(19) United States
(12) Patent Application Publication
(10) Pub. No.: US 2013/0241485 A1
(43) Pub. Date: Sep. 19, 2013

(54) GRID TIE SYSTEM AND METHOD

(71) Applicant: GLOBAL SOLAR WATER POWER SYSTEMS, INC., Poway, CA (US)

(72) Inventor: Mark E. Snyder, Poway, CA (US)

(73) Assignee: Global Solar Water Power Systems, Inc., Poway, CA (US)

(21) Appl. No.: 13/875,064

(22) Filed: May 1, 2013

Related U.S. Application Data
(63) Continuation of application No. PCT/US2011/059005, filed on Nov. 2, 2011.
(60) Provisional application No. 61/409,462, filed on Nov. 2, 2010.

(51) Int. Cl. B60L 11/18

(52) U.S. Cl. CPC B60L 11/1809
USPC 320/109; 320/128

(57) ABSTRACT

A system and method of tying a power user, such as a Plug in Hybrid Electric Vehicle into a grid system. A grid tie system can include a grid, a smart meter, an inverter, one or several power storage units, a charge controller, a dc switcher, and a charger. A grid tie system can further include a connector for connecting with the power user. A grid tie system can further include control features to monitor, manage, and regulate power generation and power consumption.

### CROSS-REFERENCE TO RELATED APPLICATIONS

This application is a continuation of PCT Application No. PCT/US2011/059005, filed Nov. 2, 2011, which claims the benefit of U.S. Patent Application No. 61/409,462, filed Nov. 2, 2010; the entirety of each of which is incorporated by reference herein.

### BACKGROUND

### Field

The technology relates to the field of electric and hybrid vehicles.

### SUMMARY

Some embodiments disclosed herein relate generally to electric vehicles, grid tie systems for vehicles that are at least partially powered by electricity and methods of making and using such systems. Also, some embodiments generally relate to the individual components and subparts of the systems described herein, as well methods of making and using the same. Some embodiments generally relate to aspects of a vehicle configured for a grid tie system, and methods of using such a configured vehicle. Some embodiments generally relate to systems, components and methods for converting a vehicle into a vehicle that is at least in part a plug-in electric vehicle and/or systems, components and methods for tying such a vehicle to a power grid.

Some embodiments relate to a kit for converting a standard hybrid vehicle into a plug in hybrid vehicle (PHEV). The kit can include, for example, connection hardware that can electrically connect the battery to an off-vehicle power source, at least one battery that can, for example, match the voltage of the original hybrid battery, and that, for example, can maintain charge balance between each of the battery cells, battery management software that can, for example, provide information relating to battery performance to an engine control unit, and suspension components.

In some aspects, the battery can be, for example, a 10 Vdc, 25 Vdc, 50 Vdc, 100 Vdc, 201.6 Vdc, 500 Vdc, or any other volt battery that can hold, for example, a 1 Ah, 5 Ah, 6.5 Ah, 10 Ah, 20 Ah, 30 Ah, 50 Ah, 100 Ah, or any other desired charge. In some aspects, the battery management software in the kit can, for example, manage the cell performance of the battery, and can specifically, for example, maintain a substantially equal charge across all of the battery cells. In some embodiments, the battery management software can be configured to maintain an equal charge, +/−0.01 Vdc, +/−0.07 Vdc, +/−0.1 Vdc. +/−0.5 Vdc, +/−1 Vdc, or any other desired charge across all of the battery cells.

Some embodiments relate to a method of selectively integrating a power user into a power system with a grid tie system. The power user can be, for example, a PHEV, a vehicle, or any other object or group of objects that can consume and produce power. The method can include, for example, determining whether to charge the at least one battery in the PHEV by requesting information relating to available power resources internal and external to the grid tie system and relating to vehicle parameters, comparing the information received from the grid tie system and from the PHEV to predetermined charging criteria, and by allowing or denying charging based on predetermined criteria. The method can further include, for example, determining whether the power system requires power, which can include receiving a request for available power resources from the power system, determining available power resources by requesting information from the PHEV relating to the amount of available power resources, including, for example, the state of charge of the PHEV batteries, the amount of fuel available for use in power generation, and the location of the vehicle, requesting delivery of available power resources to the grid tie system by requesting delivery of available battery resources and available vehicle generated power resources.

In some aspects of the method, a transponder, for example, can be used to determine the location of the vehicle. In some aspects of the method, the vehicle can have, for example, fewer available power resources when the vehicle is in a first location, and/or the vehicle can have more available power resources when the vehicle is in a second location. In some aspects, a grid tie system controller can communicate with the power system through, for example, a smart meter. In some aspects, a grid tie system controller can, for example, communicate with the PHEV. In some aspects of the method, a high voltage charge controller can, for example, charge an off-vehicle battery bank that can, for example, provide back-up power to existing power systems.

Some embodiments relate to a method of increasing the performance of at least one battery that can have, for example, the same maximum voltage as the original vehicle battery and that can be used in a PHEV. The method can include, for example, controllably cycling the charging and discharging of the battery. The cycling can include charging the battery to a first state of charge in charging cycling, and discharging the battery. Discharging the battery can, for example, include, regular discharging of the battery to second state of charge, and deep discharging of the battery to a third state of charge.

In some aspects, the first state of charge of the battery can be, for example, a 99 percent state of charge, 98 percent state of charge, 95 percent state of charge, 90 percent state of charge, 80 percent state of charge, 70 percent state of charge, 50 percent state of charge, or any other desired state of charge. In some aspects the second state of charge can be a 50 percent state of charge, 25 percent state of charge, 23 percent state of charge, 20 percent state of charge, 10 percent state of charge, 5 percent state of charge, 1 percent state of charge, or any other desired state of charge. In some aspects, the battery cycle can include, for example, one deep discharge cycle for at least every twenty regular discharge cycles, and in some aspects, the battery cycle can include, for example, one deep discharge cycle every month.

Some embodiments relate to a method of maximizing battery usage in a PHEV. In some embodiments, the method can include, for example, requesting vehicle operator input relating to desired vehicle operation mode, requesting vehicle operator input relating to estimated trip length; requesting information relating to battery charge parameters, allowing vehicle operation in the user requested mode when battery criteria exceed threshold levels, denying vehicle operation in the user requested mode when battery criteria fail to exceed threshold levels, and limiting the rate of battery power availability according to predetermined criteria that are created to maximize ideal cycling of the vehicle battery during each trip. Further, in some embodiments, cycling of the battery can increase battery performance and battery life, which cycling can include discharging the vehicle battery from a first state of charge to a second state of charge.

In some aspects of the method, the first state of charge can be, for example, a 99 percent state of charge, 98 percent state of charge, 95 percent state of charge, 90 percent state of charge, 80 percent state of charge, 70 percent state of charge, 50 percent state of charge, or any other desired state of charge. In some aspects of the method the second state of charge can be a 50 percent state of charge, 25 percent state of charge, 23 percent state of charge, 20 percent state of charge, 10 percent state of charge, 5 percent state of charge, 1 percent state of charge, or any other desired state of charge. In some aspects of the method, the desired vehicle operation mode can be the factory vehicle operation mode or can include, for example, limiting vehicle top speed. In some aspects of the method, the desired vehicle operation mode can provide solely electric power below a designated speed such as, for example, below 1 mile per hour, 5 miles per hour, 10 miles per hour, 20 miles per hour, 25 miles per hour, 50 miles per hour, 72 miles per hour, 100 miles per hour, or below any other desired speed.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 depicts one example of an embodiment of a vehicle connected to a grid tie system.

FIG. 2 depicts a top view of one example of a vehicle connected to a grid tie system.

FIGS. 3A-3E depict examples of embodiments of a user interface display.

FIG. 4-4A are examples of a schematic depicting one embodiment of the interaction between components of a vehicle configured for connection to a grid tie system.

FIGS. 5A-5B are examples of schematics depicting configurations in which a grid tie system connects power generating resources to a power system.

FIGS. 6A-6B are examples of schematics depicting configurations in which a grid tie system connects a PHEV and power generating resources to a power system.

FIG. 6C depicts one embodiment of a combiner box.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some embodiments disclosed herein relate generally to electric vehicles, grid tie systems for vehicles that are at least partially powered by electricity and methods of making and using such systems. Also, some embodiments relate to the individual components and subparts of the systems described herein, as well methods of making and using the same. Some embodiments relate to aspects of a vehicle configured for a grid tie system, and methods of using such a configured vehicle. Some embodiments relate to systems, components and methods for converting a vehicle into a vehicle that is at least in part a plug-in electric vehicle and/or systems, components and methods for tying such a vehicle to a power grid.

In some embodiments a grid tie system may be configured for tying a vehicle to a power system, such as, for example, a power grid. Additionally, such a system may include, for example, one or more components for configuring a vehicle for grid tie, hardware for configuring a power system for grid tie, and control systems and software for connecting and controlling the connection between the vehicle and the power system. For example, without being limited thereto, the systems and methods can be used for grid tie of vehicles such as cars, trucks, vans, tractor trailers, boats, air-vehicles, motorcycles and the like. However, a person skilled in the art, having the instant specification, will appreciate that the grid tie systems and methods of use of such systems disclosed herein can be applied to tying of the grid to a variety energy producers or consumers.

The following descriptions refer to several features of a grid tie system. Several of the features are described in association with one particular sub-system of the grid tie system. A person skilled in the art will recognize that these general features can be incorporated into any sub-system of the grid tie system to achieve results similar to those achieved in connection with use of the feature with another sub-system.

In some embodiments, a grid tie system can be configured to selectively integrate an energy consumer or an energy producer into a power system. More specifically, a grid tie system can be configured to selectively integrate a Plug in Hybrid Electric Vehicle (PHEV) or Electric Vehicle (EV) into a power system. Some embodiments also relate to systems, devices and methods for converting a vehicle into a PHEV, and also in some aspects to tying such vehicles to a power grid. Thus, in some embodiments, a vehicle can be connected to the power system such that it withdraws power from the power system to, for example, charge vehicle batteries. In other embodiments, a vehicle can be connected to the power system such that it provides power to the power system and thus supports power generation. In some embodiments, the vehicle can be communicatingly connected to the power system so that the vehicle responds to detected power system needs by providing available power resources including, in some aspects, one or both of stored or generated power. Connection to a power system can, in some embodiments, be facilitated by a grid tie system and vehicle components configured for grid tie.

### Grid Tie System

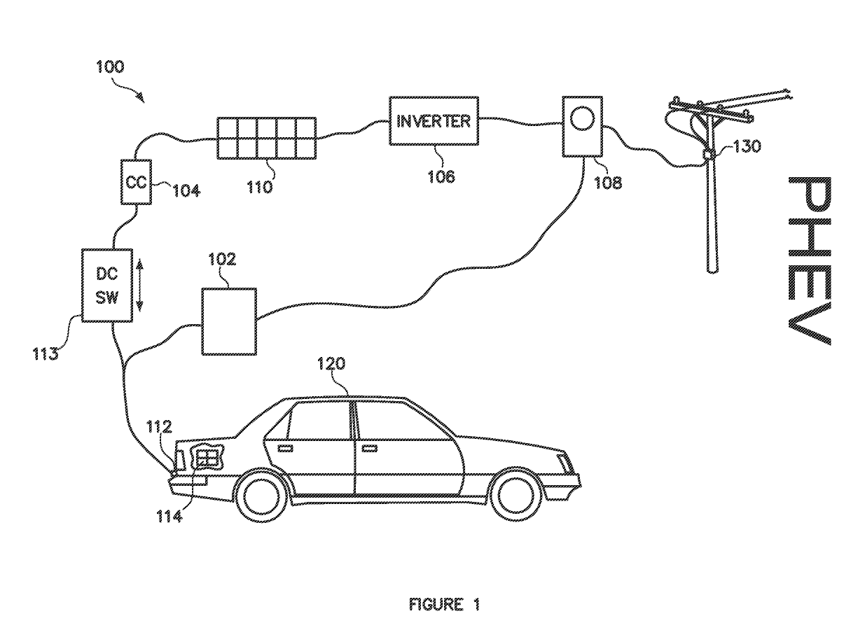

FIG. 1 depicts one embodiment of a grid tie system 100 configured for connecting a power system 130 to power user 120. A power system 130 can include a variety of components. In some embodiments, for example, a power system 130 can include a commercial power grid. In other embodiments, a power system 130 can comprise an off-the-grid power system. A power system 130 can further include power generation, power distribution, and/or power storage components, for example. In some embodiments, a power system 130 can include combustion, nuclear, solar, wind, or hydro power generation components, for example. A power system 130 can additionally include power lines or other power distribution components. A power system 130 can additionally include at least one battery, at least one capacitor, at least one fly-wheel, or any other energy storage component or mechanism.

A power user 120 can include or be, for example, a power supplier and/or a power consumer. In some embodiments, a power user 120 can be both a power supplier and a power consumer. In these embodiments, the status of the power user 120 can be determined according to factors discussed in greater detail below. As depicted in FIG. 1, a power user 120 can be a vehicle. The vehicle can be any sort of vehicle, including for example, a car, a truck, a van, a motorcycle or motorbike, a motor home, a boat, an aircraft, a tractor trailer, a tractor, a boat or ship, and the like.

Some embodiments of a grid tie system can, as depicted in FIG. 1, include at least one charger 102, at least one charge controller 104, at least one inverter 106, and at least one meter 108. A grid tie system can additionally include, for example, at least one energy storage component 110, connection hardware 112, and/or at least one dc switcher 113. In some aspects, one or more of the components depicted in FIG. 1 can be specifically excluded, for example.

A charger 102 can serve a variety of functions depending on the power requirements of the power user 120 and the power availability of the power system 130. In some embodiments, and as, for example, depicted in FIG. 1, in which the power user 120 is a vehicle, the charger 102 can control charging of at least one battery 114 within the power user 120. In some aspects, a charger 102 can control, for example, the amount of power, the type of current, or the voltage passed to the battery 114. A charger 102 may be additionally configured for various modes of charging such as, for example, simple, trickle, timer-based, intelligent, fast, pulse, or inductive. A person skilled in the art will recognize that the present disclosure is not limited to a specific type of charger or mode of charging but encompasses all chargers.

Some embodiments of a grid tie system may include a charge controller 104. A charge controller 104 can, in some aspects, regulate the rate of flow of electric current. In some aspects, a charge controller can be configured to regulate the rate at which power is added to or withdrawn from an energy storage unit 110. More specifically, a charge controller 104 can, for example, prevent overcharging or discharging of a battery by regulating the rate at which power is added to the power system 130. In some embodiments, a charge controller 104 can be configured as a charge controller characterized by eight to sixty amperes and forty-eight to three-hundred volts of direct current (Vdc). A person skilled in the art will recognize that present disclosure is not limited to any specific configuration or type of charge controller, but includes all charge controllers.

Some embodiments of a grid tie system 100 may include an inverter 106. An inverter can, in some aspects, convert direct current (dc) into alternating current (ac) or alternating current (ac) into direct current (dc), for example. In some embodiments, the inverter 106 can be configured, for example, to output a variety of voltages and frequencies. An inverter 106 can, for example, be configured to convert direct current into one-hundred twenty or two-hundred forty Vac. An inverter 106 can be located in a variety of positions. In some aspects, an inverter can be located in a position not on or in a vehicle. In another aspect, an inverter can be located within a connection location such as, for example, a garage. A person skilled in the art will recognize that the present disclosure is not limited to any specific configuration or type of inverter, but includes all inverters.

Some embodiments of a grid tie system 100 may include at least one meter 108. A meter can, in some embodiments, measure and track the amount of current coming into or exiting out of a power system 130. In some embodiments, a grid tie system 100 can, for example, include a first meter 108 configured for tracking the amount of power coming from the power system 130. A grid tie system 100, in other aspects, can include a meter 108 configured for tracking the amount of power being put back into the power system 130. In some aspects the system 130 can include one or more meters 108 configured to track the amount of power going into the system 130 and tracking the amount of power coming out of the system 130. In some aspects, a single meter can be used to track in-going and outgoing power, while in other aspects, more than one meter can be used. A person skilled in the art will recognize that a wide variety of meters in a variety of configurations may be used in connection with the present disclosure and that the present disclosure is not limited to any specific meter or configuration thereof.

Some aspects of a grid tie system 100 can include, for example, at least one energy storage component 110. An energy storage component 110 can include one or more of a variety of components including, for example, at least one battery, at least one capacitor, at least one fly-wheel or any other component capable of storing or facilitating the storage of energy. The energy storage component 110 can be diversely configured to store a broad range of currents at a broad range of voltages. In some embodiments, the energy storage component 110 may include a battery configured to store 350 Ah at 48 Vdc, A person skilled in the art will recognize that a wide variety of energy storage component configurations can be used in connection with the present disclosure and that the present disclosure is not limited to any specific energy storage component 110 or configuration thereof.

A grid tie system 100 can, in some embodiments, additionally include connection hardware 112. In some embodiments, connection hardware 112 can include, for example, an electrical connector such as, for example an SAE J1772 compliant or dc equivalent electrical connector. In some embodiments, connection hardware can additionally include communication hardware. In some embodiments, communication hardware can include, for example, wireless transmitter and receiver hardware, Ethernet technology and wiring, or any other communication hardware. A person skilled in the art will recognize that connection hardware is not specifically limited to the specific embodiments or functions disclosed herein but rather can encompass all techniques used to connect a power user 120 to a grid tie system 100.

A grid tie system 100 can, in some embodiments, additionally include, for example, the dc switcher 113. The dc switcher 113 can be positioned in any suitable or desired location, for example, it can be positioned between the charge controller 104. In some embodiments, the dc switcher 113, can be, for example, an lhv dc dc switcher. The dc switcher 113 can be configured to limit the amount of current that can flow through the dc switcher and provide protection against power surges. The dc switcher can be configured to set any desired upper threshold to the amount of current that can pass through the dc switcher. In some embodiments, the dc switcher can be configured to cap current at 110 percent of the normal system operating current, at 120 percent of the normal system operating current, at 150 percent of the normal system operating current, at 200 percent of the normal system operating current, or at any other desired operating current. In some embodiments, the dc switcher can be configured to provide surge protection. In some embodiments, the surge protection can protect again a power change of, for example, 1 percent to 100 percent (e.g., 1 percent, 5 percent, 10 percent, 25 percent, 50 percent, 100 percent) or any other current change.

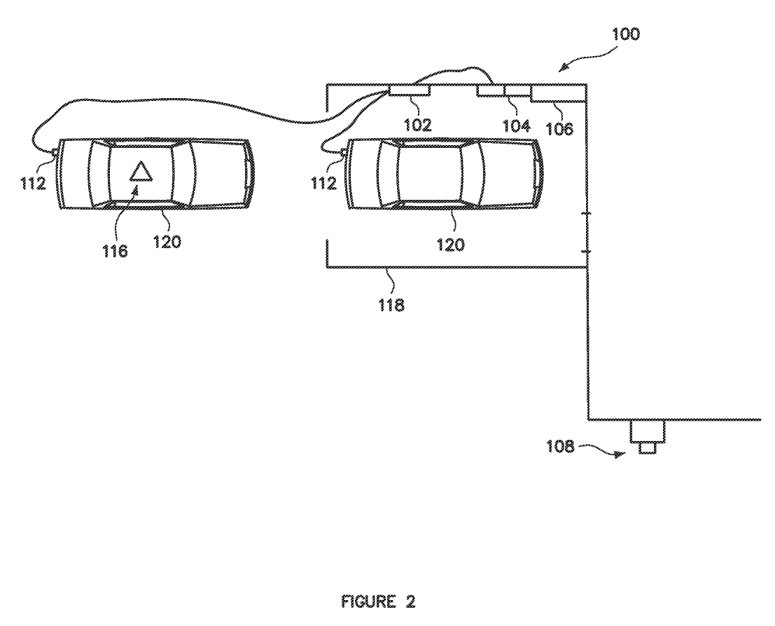

Additional aspects of a grid tie system 100 can include, for example, features configured to provide information relating to the vehicle. As depicted in FIG. 2, a grid tie system 100 for tying a power user 120 to a power system can include, for example, a charger 102, a charge controller 104, an inverter 106, a meter 108, connection hardware 112, control circuitry, at least one controller, and at least one transponder 116. In some aspects, one or more of the depicted components can be specifically excluded and/or combined, if desired.

Some embodiments of a grid tie system 100 can include control circuitry. Control circuitry can, in some embodiments, communicatingly connect a controller to the individual components of a grid tie system 100. Control circuitry can include, for example, sensors, actuators, switches, and other detection and control components.

Some embodiments of a grid tie system 100 can include a grid tie system controller. A grid tie system controller can include, for example, hardware and software configured to run on the hardware. In some aspects, grid tie system controller hardware can include a microprocessor, data storage capacity, and other well known controller components. Software can, in some embodiments, be configured to request and receive signals from components of a grid tie system 100, from the power system 130, or from the power user 120 and/or to provide control signals to components of the grid tie system 100, to the power system 130, or to the power user 120 in response to the received signals. In some embodiments, and as will be discussed in greater detail below, these received signals can include, for example, a request for available power generation capacity from the grid tie system 100, a signal relating to the power user's 120 available power generation capacity, and signals from individual components of the grid tie system 100. In some embodiments, and as also discussed in greater detail below, control signals can include, for example, a request for the power user 120 to begin power generation, a request for the power to be returned to the power system 130, or request for specific action by individual components of the grid tie system 100.

As further depicted in FIG. 2, a power user 120 can be located in areas which impact the ability of the power user 120 to accept energy from the power system 110. For example, as depicted in FIG. 2, a power user can be located in an enclosed area, such as a garage 118. In some embodiments, the location of the power user 120 can be sensed by a transponder 116.

In some aspects, a transponder 116 can be configured to provide information about the location of the power user 120. In some aspects, a transponder can detect the presence or absence of a power user and report the presence or absence to the grid tie system controller. A person skilled in the art will recognize that the transponder can include or be one or more of a variety of sensors, communication devices, or detection components including one or more of at least one pressure sensor, optical recognition components, or at least one RFID chip and reader. A person skilled in the art will recognize that a transponder is not limited to the specific embodiments disclosed herein but broadly includes all components and methods of detecting and reporting the presence or absence of the power user 120.

### Power User

Some embodiments of a grid tie system relate to power users that can interact with a power grid and/or or a grid tie system, including grids and systems as described herein. Again, a power user can be any suitable user, but in some non-limiting embodiments, may include one or more of a car, a truck, a van, a motorcycle or motorbike, a motor home, a boat, an aircraft, a tractor trailer, a tractor, and the like. Thus, some embodiments relate to power users, converted or factory built having one or more of the functionalities and/or components described below and elsewhere herein. Some embodiments relate to conversion kits for converting a vehicle into a PHEV and/or a vehicle that can be tied to a power grid as described herein.

A power user can, in some embodiments, be configured for interaction with a grid tie system 100. In some embodiments, a power user 120 can include, for example, an electric vehicle, a hybrid vehicle, or any device capable of using and/or generating energy. In some embodiments, a power user 120 configured for interaction with the grid tie system can comprise, for example, one or more of energy generation features, energy storage features, control circuitry, at least one controller, and at least one connector.

Energy generation features can comprise, for example, a variety of energy generation components including, for example, one or more of: at least one photovoltaic cell, at least one wind turbine, at least one hydro-power generator, at least one internal combustion driven generator, or any other generation means.

As discussed above, energy storage features can include a variety of components including, for example, one or more of: at least one battery, at least one capacitor, at least one fly-wheel, or any other energy storage component.

Control circuitry can, in some embodiments, communicatingly connect a controller to the individual components of a power user 120. Control circuitry can include, for example, one or more of: sensors, actuators, switches, and other detection and control components.

A power user 120 can, in some embodiments, include a controller. A controller can, for example, comprise hardware and/or software configured to run on the hardware. In some aspects, controller hardware can include one or more of: a microprocessor, data storage capacity, and other well known controller components. Software can, in some embodiments, be configured to request and receive signals from components of a power user 120, from the grid tie system 100, and/or from the power system 130. The Software also can be configured to provide control signals to components of the power user 120, to the grid tie system 100, and/or to the power system 130 in response to the received signals. In some embodiments, and as will be discussed in greater detail below, these received signals can include, for example, at least one of: a request for available power generation capacity from the grid tie system 100, a signal relating to the available power generation capacity of the components of the power user 120, and signals from the grid tie system 100. In some embodiments, and as also discussed in greater detail below, control signals can include, for example, a request for the energy generation components of the power user 120 to begin power generation or a request for power user 120 location information from the grid tie system 100. More specifically, in some embodiments in which the power user 120 generates and transfers power to the grid tie system 100, the controller can regulate the amount of power generated by the power user 120 to prevent overloading of the grid tie system 100, or components thereof, such as, for example, the inverter 106.

A power user 120 can, in some embodiments, additionally include at least one connector. In some embodiments, a connector can comprise an electrical connector such as, for example a SAE J1772 compliant or dc equivalent electrical connector matable with the connection hardware 112 of the grid tie system 100. In some embodiments, a connector can additionally comprise communication hardware. In some embodiments, communication hardware can include wireless transmitter and receiver hardware, Ethernet technology and wiring, or any other communication hardware. A person skilled in the art will recognize that a connector is not specifically limited to the specific embodiments or functions disclosed herein but rather, as discussed above, can encompass all techniques used to connect a power user 120 to a grid tie system 100.

In some specific embodiments, a hybrid vehicle or an electric vehicle may be configured for use with a grid tie system 100. In one embodiment, for example, a vehicle may be configured with grid tie capability. In some embodiments, a vehicle can be configured with a battery with any suitable or desired energy, usable energy, capacity, voltage, and maximum distance. For example, in some embodiments, a vehicle can be configured with a battery with the energy of from 1 to 200 kilowatt hour (kWh) and a usable energy of between 0.6 kWh and 180 kWh, a capacity between 2 Ampere-hour (Ah) and 200 Ah, and a voltage ranging from 12 to 500 Vdc. In some embodiments, a vehicle can be configured, for example, with a battery with the energy of 1.3 kilowatt hour (kWh) and a usable energy of 0.78 kWh or approximately sixty percent of the total charge, a 6.5 Ampere-hour (Ah) capacity, 201.6 Vdc, and can provide approximately a five mile range. In some embodiments, a vehicle can be configured, for example, with a battery with the energy of 6.1 kWh and a usable energy of 4.27 kWh or approximately seventy percent of the total charge, a 30 Ah, 201.6 Vdc, and can provide a 25 mile range. In some embodiments, a vehicle can be configured, for example, to have a battery with the energy of 12 kWh and a usable energy of 8.5 kWh or approximately seventy percent of the total charge, 50 Ah, 201.6 Vdc, and can provide a 40 mile range. Other distances are contemplated, including those from about 3 miles to about 200 miles, for example or any value in between. In some embodiments the batteries can be configured for charging. In some embodiments, a battery can be configured, for example, for charging at up to two-hundred forty Vdc and up to 120 A. A person of skill in the art will recognize that a battery can be configured with a broad range of energy, usable energy, voltage, and charge to provide a variety of ranges and functionality and that the present disclosure is not limited to the above listed examples.

In some embodiments, a vehicle can be configured with off-the-shelf batteries. In other embodiments, a vehicle can be configured with batteries configured to a desired size, weight, and power storage ability. In some aspects, the voltage of a battery can be configured to match the voltage of the original vehicle battery. In one embodiment, for example, the vehicle can be configured with nickel metal hydride batteries configured to match the battery characteristics of the original vehicle batteries. These characteristics can include, for example, battery voltage. Surprisingly, matching of the voltage of the replacement battery with the original battery enables continued use of several of the vehicle systems and thus simplifies the conversion.

Some embodiments of a converted vehicle can include a vehicle mounted battery charger. The battery charger can be configured to receive a variety of electrical inputs and to provide a variety of electrical outputs. In one embodiment, a vehicle charger can be configured, for example, to receive inputs ranging from 90 Vac to 260 Vac. In some embodiments, variation in input voltage into a charger can alter charger power output. In some embodiments, for example, the charger can provide between 0.1 kW and 3 kW of power, and more specifically 1 kW of power when the charger is provided with 120 Vac and the charger can provide between 0.1 kW and 4 kW of power, and more specifically 1.6 kW of power when the charger is provided with 240 Vac. In some embodiments, a charger receiving power at 120 Vac can, for example, be configured to provide a 5 A charge in approximately five hours and a charger receiving power at 240 Vac can be configured, for example, to provide a 6.8 A charge in approximately four to five hours. A person skilled in the art will recognize that a charger can receive a variety of inputs and create a variety of outputs and is not limited to the specific embodiments of the present disclosure.

Some embodiments of a hybrid vehicle configured for use with a grid tie system 100 can include a vehicle generator. In some embodiments, the vehicle generator can be configured to generate electricity using vehicle energy resources such as chemical energy, potential energy, kinetic energy, or any other source of vehicle energy. In some embodiments, the generator can be mechanically connected to an internal combustion engine, and can thereby generate electricity. In some embodiments, a generator can be configured to generate a broad range of power. In some specific embodiments, a generator can be configured, for example, to generate 125 A and 25 kW of electricity. In further embodiments, a generator can be configured to generate approximately 10 kWh when the internal combustion engine is running at idle. In additional aspects, a generator can be configured to generate approximately 10 kWh of electricity from a gallon of gasoline. A person of skill in the art will recognize that the present disclosure is not limited to any specific configuration of generator but encompasses all known configurations.

In some further embodiments, this conversion of a vehicle to have grid tie capability may include converting a hybrid vehicle to a plug in hybrid vehicle (PHEV), which PHEV can be configured to have the grid tie functionality described herein. Some embodiments herein relate to kits for converting a hybrid vehicle to a PHEV. The kits may include, for example, any of the components described herein, including one or more of: at least one battery, suspension components, at least one battery charger, mating connector hardware, at least one cooling fan, and/or a battery management system. In some aspects the kids can include any of the components, devices, hardware, software, etc., disclosed herein and in others any of the listed or described components, devices, hardware, software, etc. can be specifically excluded.

In some embodiments, a vehicle can be converted for use in connection with a grid tie system 100 with the addition of conversion components. In some embodiments, some or all of these components may be collected into a conversion kit. These components can include, for example, one or more of: at least one battery, suspension components, at least one battery charger, mating connector hardware, at least one cooling fan, and/or a battery management system.

In some embodiments in which a vehicle is converted for use in connection with a grid tie system 100, the original batteries of the vehicle can be supplemented or replaced by additional energy storage capacity, which can, in some embodiments, comprise additional batteries. In some embodiments, the additional batteries can comprise a variety of battery types having a variety of sizes, including, for example, lithium-ion, nickel metal hydride (NiMH) batteries and the like. A person skilled in the art will recognize that the present disclosure is not limited to the specifically disclosed battery types, but may include any battery capable of achieving desired functionality and/or output.

In some embodiments, the batteries can be configured to match the voltage output of the vehicle's original batteries while increasing the current capacity of the original batteries. A person skilled in the art will recognize a variety of techniques that can be used to increase the capacity of batteries while matching the voltage output to that of the original vehicle battery. In one embodiment, for example, the original 6.5 ampere-hour, 201.6 Vdc battery found in a Toyota Prius can be replaced by a 30 ampere-hour, 201.6 Vdc battery. In embodiments in which the replacement battery is a nickel metal hydride battery, the battery can comprise one-hundred sixty-eight, 1.2 Vdc cells connected in series to achieve the required voltage and amperage. Surprisingly, matching the voltage output of the new batteries to that of the original batteries can enable use of several original components of the vehicle and thereby greatly simplify the conversion process.

A conversion kit can additionally include replacement suspension components to counteract any weight changes caused by the conversion. A person of skill in the art will recognize that the addition or removal of components from a vehicle may alter the overall vehicle weight as well as the center of gravity. This can result in drivability and performance changes. Replacement of certain suspension components can minimize these changes in performance and drivability. In some embodiments in which, for example, weight is added to the rear of the vehicle in the form of batteries, suspension components may include stiffer springs and/or shock absorbers with a higher damping coefficient. A person of skill in the art will recognize that a wide variety of adjustments can be made to a suspension to counteract the effects of weight and center of gravity change on a vehicle and the present disclosure is not limited to any specific suspension configurations.

A conversion kit further can include mating connector hardware. In some embodiments, the mating connector hardware can, for example, comprise a plug receptacle (e.g., a bumper plug receptacle or receptacle on any other part of the vehicle) configured for receiving a SAE J1772 compliant or dc equivalent electrical connector. In other embodiments, a connector can additionally comprise communication hardware. Communication hardware can, for example, include a wireless transmitter and/or receiver hardware, Ethernet technology and wiring, or any other communication hardware. A person skilled in the art will appreciate that the connector hardware can comprise a variety of configurations and can be located at a variety of positions on the vehicle and that the configuration and location of the connector hardware is not limited to embodiments specifically disclosed herein.

Some embodiments of a conversion kit can additionally include a cooling fan. In some embodiments, this fan can be configured to create air flow over batteries or other components during heat generating use. More specifically, the fan can be configured, for example, to create air flow over batteries or other charging components during the battery charging process.

Some embodiments of a conversion kit can further include, for example, a vehicle integration manager can included hardware and/or software, for example. A vehicle integration manager can be configured to integrate conversion components, including, for example, both conversion hardware and software components with the vehicle software and vehicle hardware control systems. In some embodiments, the vehicle integration manager can be configured to interact with some or all of one or more batteries, a battery management system, a hybrid energy manger, an original engine control unit, and an electric vehicle motor booster. In some embodiments, the vehicle integration manager can be configured to communicate with other components of the vehicle, such as, for example, the batteries, the OEM ECU, the conversion BMS, a display, and a battery fan, and to facilitate communication between OEM components and conversion components. In some embodiments, the vehicle integration manager can be configured to send and receive signals relating to battery charge state and battery conditions and/or control the fan. Information contained in these signals can be communicated to the vehicle operator by the display.

In some embodiments, an electric vehicle motor power booster, or EV motor power booster, can comprise, for example, software configured to increase battery output. In some embodiments, this increased output can allow increased electric motor performance, which can in turn result in increased vehicle performance. In some embodiments, the EV motor power booster can be configured to override upper-boundaries on battery power output to thereby allow increased battery power output. In some embodiments, for example, the EV motor power booster can be configured to allow a battery output of 5 kW, 10 kW, 15 kW, 20 kW, 25 kW, 50 kW, 100 kW, or any other desired output. In some embodiments, this can create a full power electric vehicle mode, and can allow vehicle operation across a broad range of speeds, including, for example, operation up to 60 miles per hour (mph), operation up to 80 mph, operation up to 100 mph, operation up to 120 mph, or vehicle operation up to any other desired speed.

Some embodiments of a conversion kit can include a battery efficiency optimizer. In some embodiments, the battery efficiency optimizer (BEO) can comprise hardware and software configured to optimize battery energy use based on destination and route information. Thus, in some embodiments, the BEO can be configured to evaluate geographic terrain, such as, for example, road conditions, road slope, and any other factors, and driving terrain, such as, for example, expected traffic, expected driving speeds, construction, expected stop sign and/or stop lights, and any other factors to optimize battery management to maximize battery efficiency. Thus, in some embodiments, the different terrain factors can be used, in connection with the desired trip distance, to determine estimate power usage over specific portions of the trip. This estimated power usage can be used to evaluate sufficiency of vehicle power sources, and to generate plans to regulate power usage. For example, speed can be reduced or increased in response to the terrain, traffic, etc. Also, for example, the battery usage can be increased or decreased based upon the type of terrain and conditions (e.g., up hill, down hill, stop and go traffic, etc.). Thus, in some embodiments, actual power availability and actual power usage can be affected by the estimated power usage. This affect to actual power availability and usage can increase the efficiency with which the battery is used.

Some embodiments of a conversion kit can further comprise, for example, a battery management system. In some embodiments, the battery management system (BMS) can interact with the original vehicle computers including any engine control units (ECU) or original battery management systems. In some embodiments, the conversion BMS can integrate with any original ECU or BMS systems. In these embodiments, the conversion BMS can, for example, provide information relating to the charge state of the batteries to the original BMS.

The BMS can, in some embodiments, control the charging and discharging of the batteries at the pack level. In other embodiments, the BMS can control the charging and discharging of the batteries at the cell level. In some aspects, the BMS can maintain an equal charge level in each cell during the charging or discharging of the battery. In some embodiments, the BMS can maintain a charge equality ranging between +/−5 Vdc and +/−0.01 Vdc, such as, for example, +/−5 Vdc, +/−0.1 Vdc, or +/−0.07 Vdc. In other embodiments, the BMS can maintain a charge equality ranging between +/−5 percent and +/−0.01 percent, such as, for example, +/−5 percent, +/−1 percent, or +/−0.05 percent. Control of the batteries at the cell level can assist in maintaining uniform charge in each cell and uniform production from each cell. Surprisingly, control of the batteries at the cell level can significantly increase the life of the batteries as well as increases the overall battery capacity.

The BMS can additionally interact with the vehicle driver through the user interface display. In some embodiments, the user interface display can be configured to be viewable by the vehicle operator while operating the vehicle. In some embodiments, the user interface display can comprise input features and/or output features, the input features configured to allow the vehicle operator to input operation selections. A user interface display can further comprise a touch screen capable of displaying information and receiving user input.

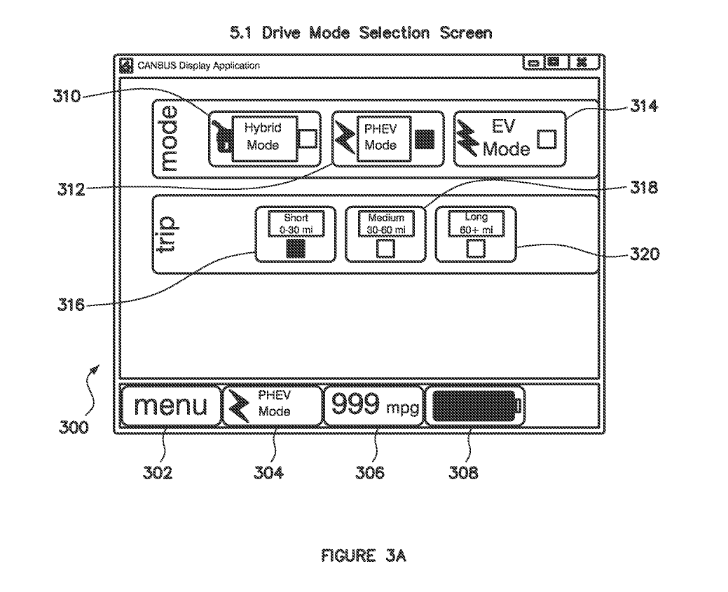

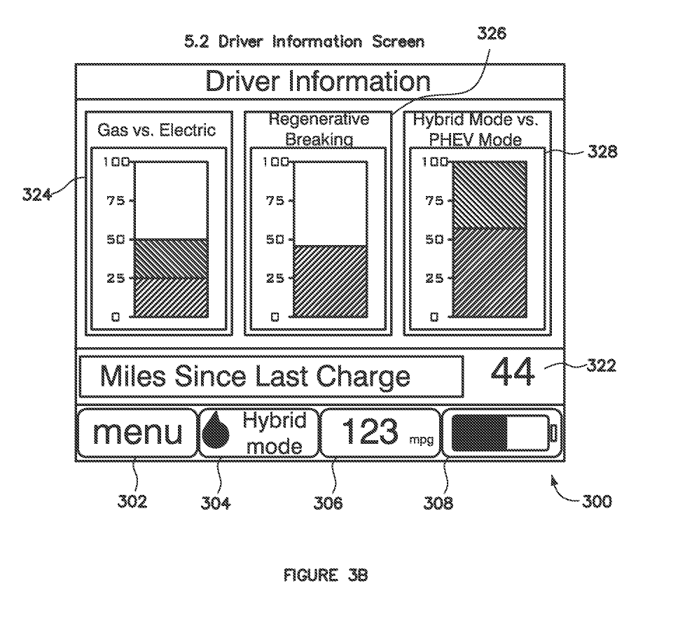

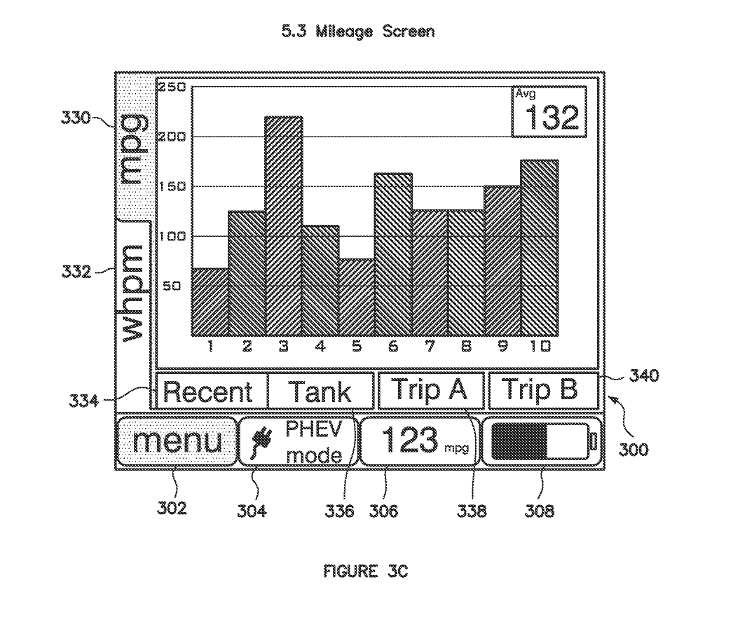

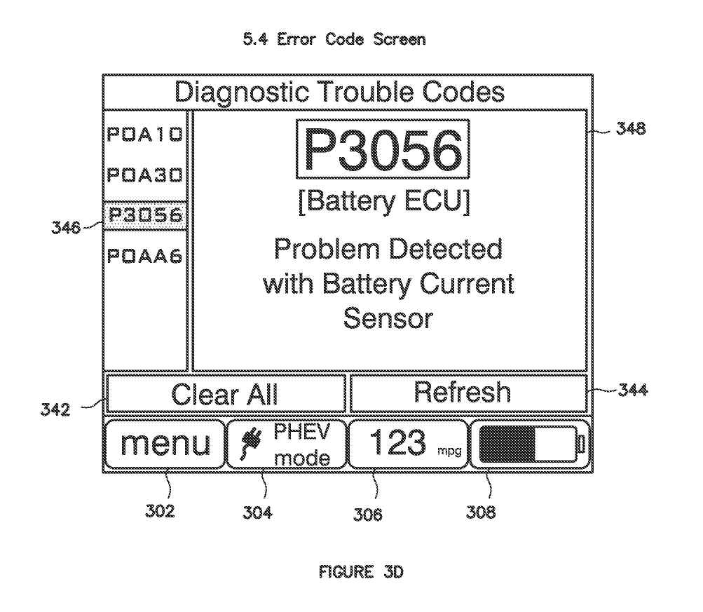

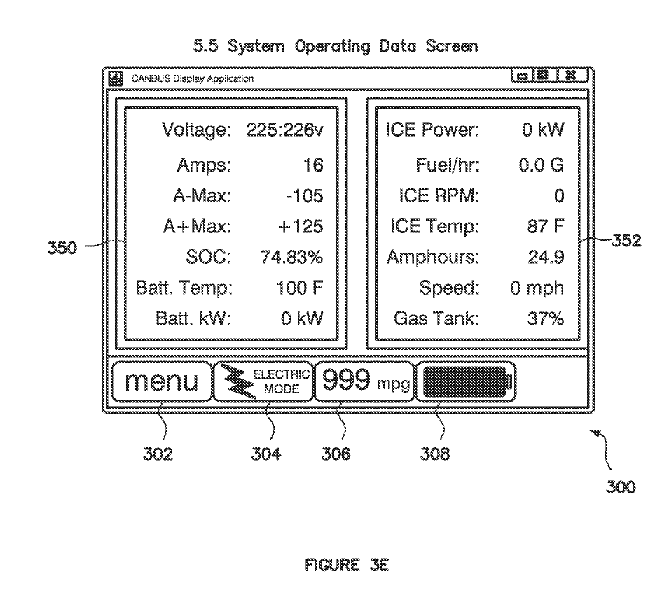

In some embodiments, a user interface display can display information relating to the vehicle operation mode and the duration of the trip. The user interface display can additionally, for example, display information relating to current vehicle performance, distance traveled since last charge or fill-up, mileage, vehicle errors, or current battery conditions. Some embodiments of possible user interface displays are depicted in FIGS. 3A-3E. In some embodiments, the interface information can be viewed on an external computing system, for example, a handheld computing device, a laptop computer, and iPad® or similar device, a desktop computer, a mobile telephone, etc., to name a few examples. In some embodiments, these devices can receive interface information via cable, wireless, or other connection.

In some embodiments, a conversion kit can include hardware and software configured to expand the functionality of any existing vehicle controls. In some embodiments, the conversion kit hardware and software can be configured to provide added functionality through, for example, an existing OEM console control panel. This increased functionality can include requesting and receiving information relating to different aspects of vehicle operation, such as, for example, different vehicle operation modes, trip information, or any other operation information. In some embodiments, the increased functionality can relate to modes of vehicle operation such as, for example, grid tie, hybrid, true electric vehicle, plug-in-hybrid vehicle, and or any other mode of operation. In some embodiments, the increased functionality can relate to a desired trip, such as, for example, trip length, such as long, medium, short, or any other desired trip length designation. In some embodiments, the increased functionality can relate to battery state, such as the battery state of charge.

FIG. 3A depicts one example of a possible output of a user interface display 300. As depicted in FIG. 3A, the user interface display 300 contains touch fields 302, 304, 306, and 308 located at the bottom of the display, which fields enable the user to select display functions. As depicted in FIG. 3A, touch field 302 allows the vehicle operator to select the menu function, touch field 304 permits the vehicle operator to select the PHEV mode, touch field 306 allows the user to select functions relating to mileage, and touch field 308 permits the vehicle operator to select functions relating to the battery. In addition to the touch fields 302-308 located at the bottom of the display, FIG. 3A additionally depicts touch field Hybrid Mode 310, touch field PHEV Mode 312, and touch field EV Mode 314, all located within the mode row. FIG. 3A also depicts touch field Short 316, touch field Medium 318, and touch field Long 320, all located in the trip row. It should be noted that the depicted touch fields are merely examples of potential touch fields and that more or fewer fields can be utilized in any combination. In some aspects, two or more of the depicted fields can be combined together, for example, so that a single touch field has the functionality of two or more of the touch fields described herein. Also, the locations of the fields can be changed so that the fields appear in any desired location.

FIG. 3B depicts a second example of a possible output of a user interface display. FIG. 3B depicts the same touch fields 302-308, located at the bottom of the user interface display, as depicted in FIG. 3A. FIG. 3B additionally depicts the distance the vehicle has traveled since its last charge 322, information relating to the relative energy taken from gasoline versus electric sources 324, the amount of energy harvested from regenerative breaking 326, and the comparative work done by the hybrid vehicle operation mode versus the PHEV vehicle operation mode 328. The depicted output is an example output and can be modified as desired to exclude any of the depicted items and/or to include additional items.

FIG. 3C depicts an additional example of a possible output of a user interface display. FIG. 3C depicts the same touch fields 302-308, located at the bottom of the user interface display, as depicted in FIG. 3A. FIG. 3C further displays information relating to distance traveled per unit of fossil fuel 330, and touch field for the display of information relating to distance traveled per unit of electricity 332. FIG. 3C additionally displays touch fields 334-340 which enable the user to select information relating to recent travel 334, travel on the current tank of fuel 336, travel in Trip A 338, and travel in Trip B 340. The depicted output is an example output and can be modified as desired to exclude any of the depicted items and touch fields, and/or to include additional items and/or touch fields.

FIG. 3D depicts an example of yet an additional possible output of a user interface display. FIG. 3D depicts the same touch fields 302-308, located at the bottom of the user interface display, as depicted in FIG. 3A. FIG. 3D further displays information relating diagnostic trouble codes (DTC). FIG. 3D includes a touch field labeled Clear All 342 for clearing the registered DTC codes and a touch field labeled Refresh 344 to recheck systems for DTC codes. FIG. 3D additionally depicts a vertically extending field DTC list field 346 located on the left side of the user interface display 300, the field containing a touch field for each detected DTC. Selection of an individual DTC in the DTC list field can, in some embodiments, result in the display of information relating to the selected DTC in error field 348. The depicted output is an example output and can be modified as desired to exclude any of the depicted items and touch fields, and/or to include additional items and/or touch fields.

FIG. 3E depicts an example of an additional possible output of a user interface display 300. FIG. 3E depicts the same touch fields 302-308, located at the bottom of the user interface display, as depicted in FIG. 3A. FIG. 3E further displays information relating to performance of the electrical power systems in electric field 350 and the internal combustion engine (ICE) systems in ICE field 352. The displayed information can include output relating to battery charge and temperature. The displayed information can additionally include data relating to ICE power production, temperature, and available fuel. The depicted output is an example output and can be modified as desired to exclude any of the depicted items and touch fields, and/or to include additional items and/or touch fields.

In some embodiments in which the vehicle is operated, the vehicle systems can be powered with the starting of the vehicle. In cases in which the vehicle is still connected to the grid tie system, the vehicle can be configured so it will not start and an error message can, in some embodiments, be displayed on the user interface display. Upon starting the vehicle, the vehicle operator can, in some embodiments, select between possible vehicle operation modes including, for example, the factory mode (e.g., the factor hybrid mode), the PHEV mode, or the True EV mode.

The factory mode (e.g., the factor hybrid mode) can be the original mode of operation of the vehicle. For example, that mode can be a gas/electric combination, which can utilize propulsion generated by the internal combustion system as well as from the electrical system.

In some embodiments, the PHEV mode can be configured to generally use only electric propulsion, at any speed, unless additional power is required. In some embodiments, the PHEV mode can be configured to use only electric propulsion at any speed below some designated speed, such as, for example, seventy-two miles per hour, unless additional power is required. In some embodiments, a PHEV can be configured for use with an off-the-shelf engine control unit (ECU), such as, for example, a Hybrid Energy Manager (HEM) or an EV motor power booster that controls the electric motor in the vehicle. In other embodiments, the PHEV can be configured for use with the original ECU. In some embodiments, the PHEV can be configured for use with multiple off-the-shelf engine control units, such as, for example, a HEM and an EV motor power booster. In some embodiments, the BMS can provide the engine control unit information relating to available battery power and available power per unit time. In some embodiments, the engine control unit can control the electric motor as well as the hybrid motor in light of this information relating to available power. Thus, in some aspects in which the conversion BMS provides less power than needed for desired vehicle performance, the conversion HEM can signal the hybrid motor to provide power to supplement the electric motor. More specifically, additional power may be required when the desired power requirements exceed some threshold level, such as, for example, during rapid acceleration or steep-uphill driving. In some aspects of a PHEV mode, additional power can be supplied by an internal combustion engine. Driving in the PHEV mode, can, for example, dramatically increase vehicle mileage. In some embodiments, mileage may approach approximately 200, 150, or 100 miles per gallon of fuel. In some embodiments, the PHEV mode can transition to the hybrid mode when the vehicle battery drops below some predetermined threshold level.

In some additional embodiments of a PHEV mode, a vehicle operator can maximize vehicle performance by selecting “short,” “medium,” or “long” depending on the duration of the trip. In some embodiments, the different trip durations can change the rate of battery discharge. Thus, in “short” mode, some embodiments of a conversion BMS can allow use of unlimited power per unit time until the battery reaches a minimum threshold, such as, for example, forty percent charge, twenty percent charge, ten percent charge, or five percent charge. In some embodiments, selection of “medium” or “long” can result in the BMS placing restrictions on the availability of power per unit time, thus increasing the likely duration of battery power during use. Thus, in one embodiment, the rate of battery discharge can be slower in the “long” trip configuration than in the “short” or “medium” trip configuration.

In some additional embodiments, battery discharge can be further facilitated by providing components to discharge the batteries after travel with the vehicle is concluded. In some embodiments the batteries can be discharged by powering at least one resistor, at least one motor, or at least one other battery. In some embodiments, the batteries can be discharged to a desired discharge level, such as, for example, approximately 60 percent discharged, approximately 77 percent discharged, approximately 90 percent discharged, approximately 99 percent discharged, or approximately 100 percent discharged. In some embodiments batteries can be discharged to any discharge level in a range between 50 and 100 percent discharged. More specifically, in some embodiments, a battery can be, for example, discharged to an approximately 1 to 40 percent state of charge or in some embodiments, for example, to an approximately 23 percent state of charge. In some further embodiments, a battery can be, for example, discharged when its charge level is at or below a threshold level, such as, for example between 80 percent charge and 40 percent charge, or in some embodiments, at or below 80 percent charge, 60 percent charge, or 40 percent charge. In one embodiment, a battery at or below 60 percent charge can be discharged to approximately 23 percent charge. In other embodiments, the vehicle may be configured to discharge remaining battery power to the grid tie system upon completion of travel.

More specifically, in one embodiment, the True EV discharge rates can be, for example, based on travel on flat roadway, with two passengers, and little or no head winds. In another aspect, EV discharge rates can be, for example, based on driving speed. A person of skill in the art will recognize that discharge rates will be based on a variety of factors such as engine size, vehicle weight, and vehicle aerodynamic factors as well as desired rates of discharge. Thus, in some embodiments, vehicles traveling at speeds between 1 and 95 mph can have discharge rates between approximately 10 watt-hours per mile and 2 kilowatt-hours per mile. Thus, in one embodiment in which a vehicle is traveling 10 miles per hour (mph), the True EV discharge rate can be, for example, 180 watt-hours per mile and 20 A. In one embodiment in which a vehicle is traveling 20 mph, the True EV discharge rate can be, for example, 200 watt-hours per mile and 30 A. In one embodiment in which a vehicle is traveling 30 mph, the True EV discharge rate can be, for example, 230 watt-hours per mile and 40 A. In one embodiment in which a vehicle is traveling 40 mph, the True EV discharge rate can be, for example, 250 watt-hours per mile and 60 A. In one embodiment in which a vehicle is traveling 50 mph, the True EV discharge rate can be, for example, 300 watt-hours per mile and 80 A. In one embodiment in which a vehicle is traveling 60 mph, the True EV discharge rate can be, for example, 350 watt-hours per mile and 100 A. In one embodiment in which a vehicle is traveling 70 mph, the True EV discharge rate can be, for example, 425 watt-hours per mile and 120 A.

Surprisingly, use of different modes that correlate to the expected length of travel in a trip can, in some embodiments, increase the effective capacity of the battery and increase the life of the battery by achieving frequent complete cycling of the battery. Additionally, correlation of power availability to expected trip length can, for example, increase vehicle mileage by increasing utilization of battery power in each trip.

In some embodiments, True EV mode can be configured to generally use only electric propulsion, unless additional power is required. As discussed above, in this mode, the BMS can provide the engine control unit information relating to available battery power and available power per unit time. In some embodiments, the engine control unit can control the electric motor as well as the internal combustion engine in light of this information relating to available power. Thus, in some aspects in which the conversion BMS provides less power than needed for desired vehicle performance, the conversion HEM can signal the hybrid motor to provide power to supplement the electric motor. More specifically, additional power may be required when the desired power requirements exceeds some threshold level, such as, for example, during extreme acceleration or extreme steep uphill. In contrast to the PHEV modes such as, for example, short, medium, or long, that can, in some aspects, be configured for electric only propulsion at any speed or at any speed below a predetermined speed such as, for example 50-80 mph, preferably about 72 mph, True EV mode can, in some embodiments, be configured to limit speed. Additionally, as discussed above, selection of PHEV mode and selection of expected trip length can, in some aspect, alter the rate at which the conversion BMS sets battery power usage. A person of skill in the art will recognize that the present disclosure is not limited to the specific, above-discussed trip lengths or modes of vehicle operation.

Surprisingly, control systems as described above and elsewhere herein significantly increase the usable storage capacity of the batteries used in the vehicle. In some embodiments, this increase has more than doubled the effective battery capacity.

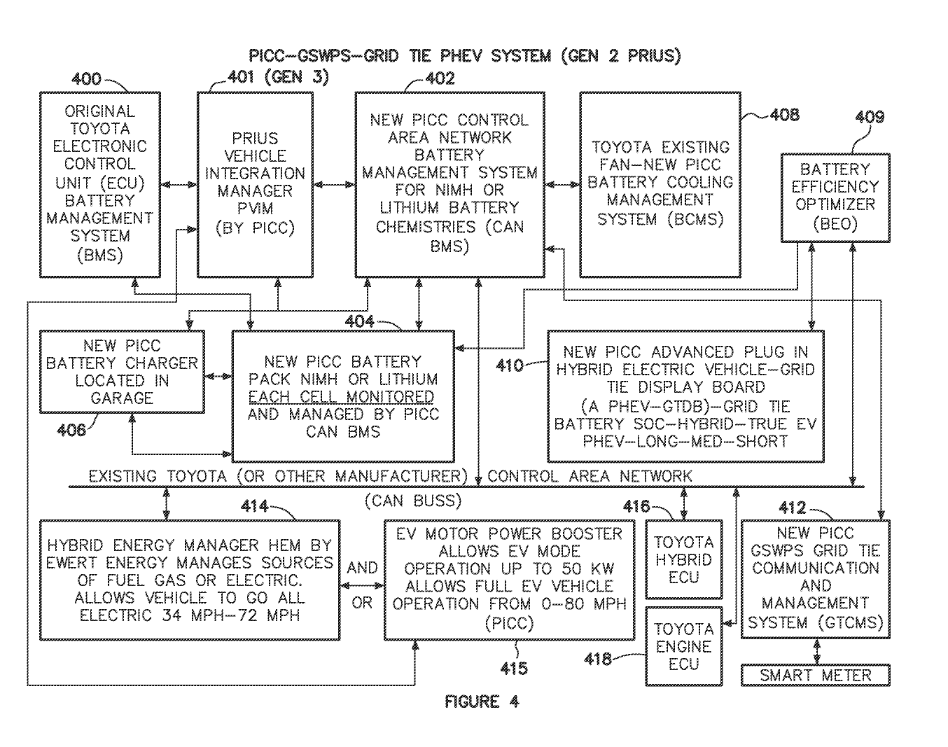

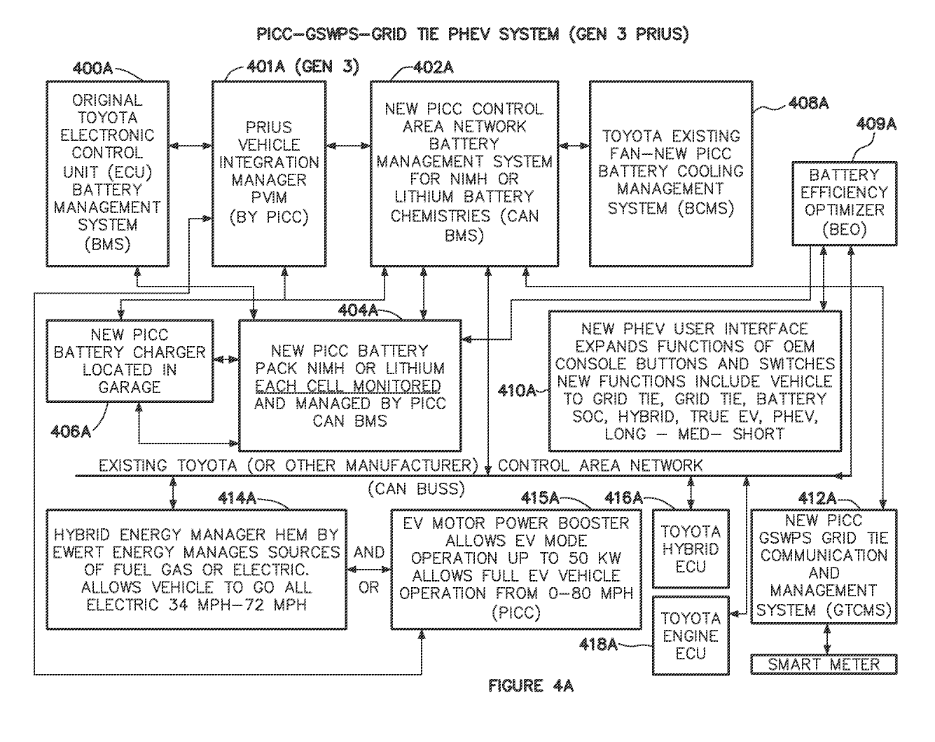

The vehicle components discussed above, as well as some original vehicle components can, in some embodiments, interact during the operation of the vehicle. Additionally, in some embodiments, vehicle components can interact with grid tie system components. FIGS. 4 and 4A depict examples of the interaction of the components of the vehicle and the grid tie system. As seen in FIGS. 4 and 4A, the details of the interaction between the components of the vehicle and the grid tie system can vary based on the specific vehicle components and the specific grid tie system components. FIG. 4 specifically depicts one exemplary embodiment of how a grid tie system can interact with components of a hybrid vehicle, such as, for example, a second generation Toyota Prius®. FIG. 4A specifically depicts one example of an embodiment of how a grid tie system can interact with components of a second hybrid vehicle, such as, for example, a third generation Toyota Prius. Referring to FIG. 4, block 400 depicts the original vehicle ECU and BMS. In some embodiments, the original ECU and BMS can be connected to a vehicle integration manager 401. A vehicle integration manager 401, as discussed above, can be configured to, for example, facilitate the integration of software and hardware components. In some embodiments, and as depicted in FIG. 4, the vehicle integration manager can comprise a prius vehicle integration manager.

In some embodiments, the vehicle integration manager 401 is connected to the conversion BMS, depicted in block 402. This connection can, in some embodiments, enable the conversion BMS to provide information to the original ECU and BMS relating to battery conditions such as battery charge or battery temperature. Additionally, by interacting with the original ECU and BMS, performance of central vehicle functions can be performed by original equipment functioning under original conditions. As further depicted in FIG. 4, the original ECU and BMS are also connected with the vehicle batteries 404. It should be noted that it is contemplated that vehicles will be configured out of the factory with a BMS and/or ECU having one or more of the functionalities of the depicted block/systems 400 and 402. In such cases, blocks/systems 400 and 402 can be combined into a single block or system. Similarly, in the case where the functionalities and systems described herein are standard or factory original, then one or more of the systems/blocks can be combined.

As further depicted in FIG. 4, the vehicle integration manager 401 can be, for example, connected to the on-board battery charger 406, and the EV motor power booster 415. As further depicted in FIG. 4, the conversion BMS 402 can be, for example, connected to the batteries 404, the on-board battery charger 406, the existing fan 408, the battery efficiency optimizer 409, the user interface display 410, and the grid tie communication and management system 412. In some embodiments, the conversion BMS can be additionally tied to a Hybrid Energy Manager 414, the vehicle hybrid ECU 416, and to the engine ECU 418.

In some embodiments, the grid tie communication and management system 412 can communicatingly interact with the grid tie system, the power system, and vehicle systems to take power from and put power into the power system. In some aspects, the grid tie system controller can communicate with the vehicle and the power system to optimize vehicle fuel consumption while delivering requested power to the power system. In some embodiments, the grid tie system controller can be configured to communicate with the power system administrator through the smart meter. The grid tie system controller can, in some aspects, be further configured to request and receive information relating to factors relevant to available vehicle power resources, such as, for example, vehicle location, and information relating to power needs, such as, for example, amount of power needed (kWh) and needed voltage. In some aspects, the grid tie system controller can be configured to communicate power needs to the vehicle. In some embodiments, these power needs may arise, for example, from the power system, the user system, or any other power consumer.

In operation, the conversion BMS 402 can request and receive signals relating to status of each component to which it is connected. In some embodiments, for example, the conversion BMS can request information from the batteries relating to the state of charge, available power, or temperature. In some embodiments, such as, for example, when the battery temperature exceeds some threshold, the conversion BMS can request operation of the fan to create airflow to cool the batteries. In some embodiments, a fan can communicatingly connect with the conversion BMS. When the conversion BMS can monitor battery temperatures and control the fan in light of measured battery temperatures. Thus, in one embodiment, for example, the fan can be activated when temperatures exceed, for example, approximately 130 degrees Fahrenheit, 122 degrees Fahrenheit, 113 degrees Fahrenheit, 110 degrees Fahrenheit, 93 degrees Fahrenheit, 78 degrees Fahrenheit, or 50 degrees Fahrenheit. In some embodiments, the conversion BMS can use a variable speed fan operation, with low speed operation beginning when battery temperatures reach at least about 40 degrees, 50 degrees, but more preferably about 78 degrees Fahrenheit (or any temperature therebetween) and high speed fan operation for all battery temperatures exceeding about 75, 80, 85 degrees, more preferably about 93 degrees Fahrenheit or more (or any temperature therebetween). In some embodiments, the conversion BMS can be further configured to stop charging and or signal an alarm when designated temperatures are achieved. Thus, in some embodiments of a battery in which cell degradation begins, for example, at 113 degrees Fahrenheit and in which major cell damage occurs at, for example, temperatures exceeding 122 degrees Fahrenheit, the conversion BMS can be configured to request stopping of charging and sounding of an alarm at, for example 110 degrees Fahrenheit or any lower temperature.

In other aspects, such as, for example, during vehicle operation, if the battery level drops to or below some pre-determine state of charge, such as thirty percent, twenty-five percent, twenty-three percent, ten percent, five percent, or one percent, the conversion BMS can signal low battery power to the original BMS, which can, in some configurations, result in switching of vehicle operation mode from electric to hybrid operation including use of an internal combustion engine.

Similarly, in some embodiments, the conversion BMS 402 can receive information from multiple sources and then, in light of the multiple signals, generate control requests. For example, in one embodiment, the conversion BMS can receive information from the user interface display relating to the desired mode of operation and desired trip distance. The conversion BMS can then request information relating to current battery conditions. Using information received from the user interface display and from the battery, the BMS can, according to preset criteria, select a vehicle operation mode. For example, if the vehicle operator inputs a long trip and EV mode of operation, the BMS can determine whether battery conditions are sufficient for such a trip request.

In one embodiment, for example, a user may request PHEV operation mode and select a long trip. The BMS can, for example, query the batteries to determine their state of charge. In one embodiment in which the state of charge is at or below, for example, about ten to about thirty percent, preferably about twenty-three percent, the conversion BMS can deny the user request for operation in the PHEV mode configured for a long trip and signal vehicle operation in hybrid mode. In contrast, in another embodiment in which the battery state of charge is above, for example, about ten to about thirty percent, preferably about twenty-three percent, the conversion BMS can signal operation of the PHEV in True EV, long trip mode until the battery state of charge is too low, such as, for example, below twenty-three percent.

Similarly, the BMS can communicate with the grid tie communication and management system 412. In some embodiments, the grid tie communication and management system 412 may receive a vehicle charging request from the conversion BMS 402. The grid tie communication and management system 412 can, for example, communicate the availability of power for charging to the conversion BMS 402. In response to this signal, the conversion BMS can prepare for charging, in embodiments in which power for charging is available, or await the availability of power. If power for charging is available, the conversion BMS can, for example, request charging from the battery charger and request running of the fan to assist in cooling electrical components during charging.

FIG. 4A specifically depicts one exemplary embodiment of how a grid tie system can interact with components of a hybrid vehicle, such as, for example, a third generation Toyota Prius. FIG. 4A depicts an original vehicle ECU and BMS 400A, a vehicle integration manager 401A, a conversion BMS 402A, vehicle batteries 404A, an on-board battery charger 406A, an EV motor power booster 415A, an existing fan 408A, a battery efficiency optimizer 409A, a user interface display 410A, a grid tie communication and management system 412A, a Hybrid Energy Manager 414A, a vehicle hybrid ECU 416A, and an engine ECU 418A. In some embodiments, the grid tie communication and management system 412A can comprise an independent and new display configured to provide information to and receive inputs from a user. In some embodiments, the grid tie communication and management system 412A can comprise software configured to expand the functionality pre-installed vehicle components, such as, for example, an OEM display.

In some embodiments, the PHEV can be configured with data tracking and recording features to track performance of different vehicle components. In some embodiments, the conversion BMS can be, for example, configured to track data relating to battery performance, such as, for example, power demands on the battery, power availability, changes in state of charge, and battery temperature. A person of skill in the art will recognize that a variety of other battery variables can be tracked and recorded.

In some aspects, battery performance can be tested or verified through use of testing software or testing equipment. In some aspects, testing can be performed by requesting power from the conversion BMS and evaluating battery performance in light of the power requests. In some embodiments, power requests from the conversion BMS can be configured to match power requests taken from normal vehicle operation. Thus, in one aspect, BMS power requests occurring while driving the vehicle can be, for example, recorded and utilized during testing. In some aspects, battery usage and battery parameters tracked by a vehicle can, for example, be utilized during the test procedure. In such an embodiment, power can be requested from the battery in the same manner as was requested during the vehicle operation.

In some further aspects of testing procedures, power extracted from the battery during testing can be dissipated through the use of resistive heaters, motors, or any other technique. Additionally, in some embodiments, power extracted from the battery during testing can be supplied to the power system through a grid tie system.

A person skilled in the art will recognize that a variety of battery testing techniques, equipment, and procedures can be used and that the present disclosure is not limited to the above outlined embodiments.

### System Integration

In some embodiments, a vehicle configured for grid tie and a grid tie system can cooperatively interact with the power system to charge energy storage components in the vehicle when sufficient power is available from the power system or to provide excess or generated power to the grid, including for example, when a grid power shortage is detected.

Surprisingly, controlling the complete battery cycling, including battery state of charge achieved during charging and discharging, increases battery life and performance. In some embodiments, control of battery cycling can, for example, increase battery life by approximately thirty to fifty percent. In further embodiments, control of battery cycling can, for example, increase battery performance by approximately thirty to fifty percent. In one embodiment of battery cycling, a battery can be, for example, cycled through a normal cycle and through a deep cycle. In some embodiments, a normal battery cycle can, for example, include charging the battery to a ninety percent state of charge. In further embodiments, a normal battery cycle can, for example, include discharging a battery to a ten to thirty percent, preferably about twenty-three percent state of charge. More specifically, in a battery configured for use in Toyota Prius, one embodiment of a normal battery cycle can comprise charging the battery to a ninety percent state of charge, 30 A-h capacity at two-hundred forty Vdc, and discharging the battery to a 23 percent state of charge, 6.9 A-h capacity at one-hundred ninety-five Vdc.

In some further embodiment, the conversion BMS can be, for example, configured to occasionally cycle the batteries through a deep cycle. In one embodiment, the conversion BMS can be configured to cycle the batteries through a deep cycle, for example, one a month, or once every twenty normal battery cycles. In one embodiment, the conversion BMS can, for example, be configured to discharge the battery to approximately three to 10 percent, preferably about five percent state of charge once every ten to fifty cycles, preferably every twenty cycles. More specifically, in a battery configured for use in Toyota Prius, one embodiment of a deep cycle can include discharging the batteries to a three to 10 percent, preferably about a five percent state of charge, 100.8 Vdc or approximately 0.6 Vdc per cell.

In some embodiments, and as depicted in FIG. 2, a vehicle is connected to a grid tie system. In some embodiments, a conversion BMS can communicate with components of the grid tie system, for example, by one or more of Ethernet, wireless, or other communication technology. The conversion BMS can communicate the state of charge of the vehicle's batteries and/or whether charging is desired, for example. In other configurations of a vehicle connected to a grid tie system, a grid tie system can default to charging. In embodiments in which a vehicle requests charging or the grid tie system defaults to charging, the grid tie system controller can request information relating to the present availability of electricity. In some further embodiments of a grid tie system, a grid tie system may request further information regarding available power, including one or more of: price per power unit, source of generated power, and/or current household power consumption requirements. Upon receiving information relating to the power supply, some embodiments of a grid tie controller can compare received information to pre-determined criteria such as, for example, an expected power price point, current system generation capacity, and/or current power consumption. In some embodiments, the comparison with the pre-determined criteria can, for example indicate approval for charging, disapproval for charging, or conditional approval for charging. Thus, in one embodiment, charging may be approved when, for example, information indicates that power prices are comparatively low, that current power consumption is low, and/or that excess power is currently being generated, or can be generated, within the system. Similarly, charging may be denied when information indicates, for example, that power costs are comparatively high, that power consumption is high, and/or that power needs are not being met by in-system power generation. Thus, in conditions in which charging criteria are met, some embodiments of a grid tie controller can call for charging. Similarly, in conditions in which charging criteria are not met, some embodiments of a grid tie controller can call for no charging. In conditions in which conditional charging criteria are met, some embodiments of a grid tie controller can request further information from the conversion BMS or power system before granting or denying permission for charging. If permission for charging is denied, the grid tie system can wait until conditions meet charging criteria and charging can begin, or until the vehicle is disconnected from the grid tie system.

It should be noted that although a “conversion” BMS is mentioned in this and the following paragraphs, a BMS that is standard to a system or factory to a vehicle is also contemplated. For ease of reference, “conversion” BMS is used, but should not be construed as limiting the systems only to conversion BMS as any suitably configured BMS can be used and configured to have the described functionalities.

In embodiments in which charging conditions are met, the grid tie system controller can call for charging and power from the power system. The power can pass through a meter and the other various components of the grid tie system, and into the vehicle batteries. In some embodiments, communication can be maintained between a conversion BMS (e.g., as described elsewhere herein) and the grid tie system controller throughout the charging process. This communication can, in some embodiments, relate to conditions within the vehicle and within the components of the grid tie system as well as to the amount of available power from the power system.

In some embodiments, a conversion BMS can be connected to at least one temperature sensor. In other embodiments, a conversion BMS can be connected to an onboard charger that can, for example, be further connected to at least one temperature sensor.

In one embodiment, a conversion BMS can be communicatingly connected with the onboard charger which can be communicatingly connected with three temperature sensors located throughout the batteries. The charger can charge the batteries and can, in some aspects, be configured for automatic shut-off when the batteries reach a predetermined voltage and a predetermined state of balance such as, for example three hundred Vdc, two-hundred forty Vdc, or one-hundred Vdc and about +/−5 to about +/−0.01 Vdc (preferably about +/−5 Vdc, +/−0.1 Vdc, or +/−0.07 Vdc) across all battery cells, or when any of the battery temperature sensors indicate a temperature above, for example, 60 degrees Celsius, 55 degrees Celsius, or 45 degrees Celsius. In embodiments in which charging stops upon reaching a voltage or temperature threshold such as, for example, three hundred Vdc, two-hundred forty Vdc, or one-hundred Vdc and about +/−5 to about +/−0.01 Vdc (preferably about +/−5 Vdc, +/−0.1 Vdc, or +/−0.07 Vdc) across all battery cells, or when any of the battery temperature sensors indicate a temperature above, for example, 60 degrees Celsius, 55 degrees Celsius, or 45 degrees Celsius, the vehicle and the grid tie system can be configured to stop charging until the vehicle is disconnected from and reconnected to the grid tie system.

In further embodiments of battery charging, a conversion BMS can monitor current flow into the battery. Additionally, the BMS can continuously, or at designated intervals, such as every minute, every second, or multiple times per second, request state of charge information from the battery. This information can, in some aspects, be stored in memory associated with the BMS and can, in some embodiments, be used to provide the vehicle operator battery state of charge information upon start-up.

In some further either embodiments, the conversion BMS or the onboard charger can request that cooling fans located in the vehicle run during vehicle charging to maintain safe component temperatures, such as, for example, under 300 degrees Fahrenheit, under 200 degrees Fahrenheit, under 122 degrees Fahrenheit, under 113 degrees Fahrenheit, or under 110 degrees Fahrenheit. In some embodiments, the conversion BMS or the onboard charger can request running of fans until charging is completed. In other embodiments, the fans can be configured to run from the start of charging until the vehicle is disconnected from the grid tie system. In a similar manner, the conversion BMS or the onboard generator can request that cooling fans located in the vehicle run during vehicle power generation to maintain safe component temperatures, such as, for example, under 300 degrees Fahrenheit, under 200 degrees Fahrenheit, under 122 degrees Fahrenheit, under 113 degrees Fahrenheit, or under 110 degrees Fahrenheit. In some embodiments in which battery, component, or engine temperatures exceed such a temperature threshold, the engine can be configured to shutdown, automatically or upon request from a controller. A person skilled in the art will recognize that the charging is not limited to the specific embodiments disclosed herein.

In some embodiments a power system can, for example, request information relating to available power sources. More specifically, the power system administrator can communicate with the grid tie system through the smart meter. A grid tie system controller receiving this request can query for information relating to available power resources. The grid tie system can receive information relating to whether the PHEV or EV is connected to the grid tie system. In embodiments in which the PHEV or EV is connected to the grid tie system, the grid tie system controller can request information from the conversion BMS as to the vehicle's available energy resources. In some embodiments, the conversion BMS may provide information relating to the state of charge of the batteries. In other embodiments, the conversion BMS may provide information relating to vehicle's energy generation capacity and current fossil fuel levels.

In some embodiments, the conversion BMS or the grid tie system controller may request information relating to the position of the vehicle. In some embodiments configured with a transponder, the transponder may determine the presence or absence of the vehicle, for example, in an enclosed area or in an unenclosed area. In some aspects, information received from the transponder relating to vehicle location can be evaluated to determine vehicle power generation capacity. Thus, in embodiments in which the transponder indicates that the vehicle is located within an enclosed or a partially enclosed area, such as, for example, a garage or a commercial parking structure, the vehicle will have less power generation capacity as it can, for example, less safely run an internal combustion engine in an enclosed area. In contrast, in some embodiments in which the transponder indicates that the vehicle is located in an unenclosed area, the vehicle will have a greater power generation capacity as it can, for example, more safely run an internal combustion engine.

Some embodiments of a grid tie system and PHEV can include additional safety features. In some aspects, a grid tie system or PHEV can include, for example, a carbon monoxide sensor. In some embodiments, a carbon monoxide sensor can, for example, be configured to measure carbon monoxide levels in vehicle cabin air or in ambient air surrounding the vehicle. In some aspects, a carbon monoxide sensor can, for example, be configured to signal to stop the internal combustion engine when either ambient or cabin carbon monoxide levels exceed a threshold, such as, for example, a government determined safe carbon monoxide level. In some aspects, a carbon monoxide sensor can serve as a fail safe in prevent operation of the internal combustion engine in areas that are unsuited to combustion.

In embodiments in which the conversion BMS determines the available power resources of the vehicle, this information can, for example, be communicated to the grid tie system controller, which can, in some embodiments, relay this information to the power system. In some embodiments, the power system may not request available power resources and the grid tie system and vehicle will return to stand-by status. In other embodiments, the power system may request available power resources. In embodiments in which the power system requests available power resources, the grid tie system controller can receive this request. In some embodiments, the grid tie system controller can, for example, request system changes to configure the grid tie system for providing power to the power system. In some embodiments, these signals can include requesting switching the grid tie system from charging to power supplying.

In further embodiments, the grid tie system controller can request that the conversion BMS provide available power resources to the grid tie system. The conversion BMS can receive this communication from the grid tie system and can signal the provision of available power resources to the grid tie system. In some embodiments, for example, power resources can be first taken from the vehicle batteries and then, if more power resources are required, additional power needs can be met, for example, through vehicle power generation until the vehicle has insufficient fuel to continue power generation. In some embodiments in which PHEV or EV location information indicates that generation of power is unsafe, the conversion BMS may request that the batteries supply power to the grid tie system. In such embodiments, the conversion BMS can request that the batteries supply power to the grid tie system until the battery state of charge drops below a predetermined threshold, such as, for example, 40 percent state of charge, 30 percent state of charge, 23 percent state of charge, 10 percent state of charge, 5 percent state of charge, or any other desired state of charge, in which case the conversion BMS can, for example, signal the battery to suspend supplying of power to the grid tie system. A person of skill in the art will recognize that the predetermined threshold can be any point at which the battery can no longer safely provide power to the system, and may, for example, be approximately 200 Vdc, 180 Vdc, or 50 Vdc (e.g., between about 200 Vdc and about 50Vdc).

In one embodiment, for example, a power system administrator can request an amount of power for a length of time. In one embodiment, for example, the power system administrator can request 10 kW for four hours (40 kWh) to support an anticipated brown-out condition. In one embodiment, for example, the grid tie controller can request and receive information relating to the location of the vehicle and to available vehicle power resources, such as, for example, in embodiments in which the vehicle has a fully charged 12 kWh battery pack capable of powering the vehicle for a forty mile trip, 8.5 kW of power can be first made available from the battery pack for one hour. In embodiments in which more power is required than can be supplied from either power generation or from the battery pack when the vehicle is not capable of generating power additional to that stored in the battery, the power system administrator can be notified of the limitations on available power resources. The power system administrator can determine whether to receive power from the vehicle in embodiments in which the vehicle does not have sufficient available power resources to match the power system needs, and can signal the grid tie controller as to whether power will be taken from the grid tie system.

In some embodiments in which the grid tie system has the required available power resources, the grid tie controller can request power generation by the vehicle. In the specific above described embodiment in which 10 kW is required for four hours (40 kWh), after the power of the battery pack is delivered, the grid tie controller can request vehicle power generation, the vehicle engine can start, and the vehicle engine can attain the required speed to deliver 10 kW for four hours (40 kWh). After the grid tie system has delivered the predetermined amount of power to the power system for the predetermine time, the grid tie system can request information relating to any further power needs of the power system. In embodiments in which the power system requires further power, the grid tie system can request and receive information relating to additional vehicle power generation resources. If additional power resources are available, the grid tie system can request further power resources until either the power need is fully met or no further power resources are available. In some embodiments in which the power resources are met or no further power resources are available, the grid tie system can request stoppage of power generation. In some additional embodiments in which power from the power system becomes available, the grid tie system can begin recharging of the vehicle batteries using power from the power system.

In some embodiments, the grid tie system controller can be further configured to deliver power at prescribed times such as, for example, during peak hours of four to seven p.m. during summer months. In further embodiments of a grid tie system, the system can be configured to receive information from the vehicle owner relating to expected times of vehicle availability for providing power resources. This information can include data relating to expected vehicle location and expected battery state of charge or fuel capacity. In some embodiments, the grid tie system can be configured, for example, to provide the vehicle use with an account, the account configured to track information relating to anticipated available power resources.

In embodiments in which PHEV or EV location information indicates that the generation of power is safe, the conversion BMS may request that the vehicle begin running to generate power. In some embodiments, the conversion BMS can request the generation of a broad range of power limited by the generation capabilities of the vehicle, the power transmission capabilities of the vehicle and the grid tie system, and the amount of power requested by the power system. This request can, in some embodiments, automatically start the vehicle internal combustion engine and achieve a requested power output. The conversion BMS can, for example, remain in communication with the grid tie system controller and can continue to request the generation of power at desired levels until the amount of available fossil fuel drops below some threshold level such as, for example, below 30 percent of fuel tank capacity, below 20 percent of fuel tank capacity, or below 10 percent of fuel tank capacity, until unsafe temperatures, such as, for example, about 100 to about 175 degrees Fahrenheit, or for example about 150 degrees Fahrenheit, 130 degrees Fahrenheit, 120 degrees Fahrenheit, 100 degrees Fahrenheit, or any other unsafe temperature, are achieved, or until the power system signals that power is no longer required. In some embodiments, a vehicle can generate 10 kWh for each gallon of fuel.

Additionally, in embodiments in which power is supplied to a power system, the meter can be configured to track the amount of power supplied to the system, enabling the vehicle owner to collect payment or receive credit for power supplied to the grid.

In some embodiments in which power resources are supplied to the power system through the grid tie system, the user interface display can display one or more of: the status of the power supply, the amount of power supplied, and the amount of power that can still be supplied. This information can be, for example, additionally communicated to the grid tie system controller, and from the grid tie system controller to the power system.

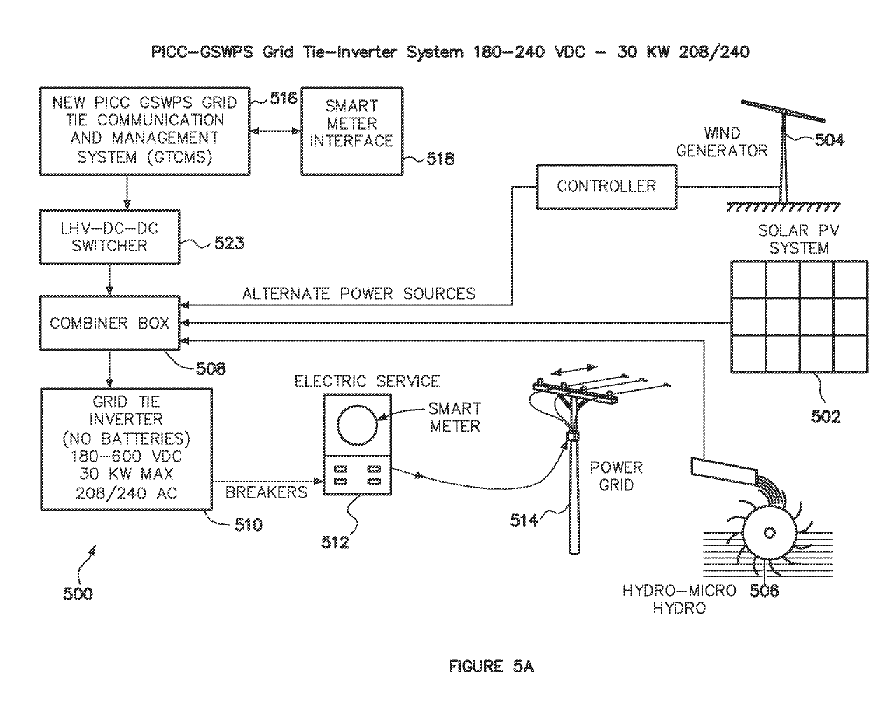

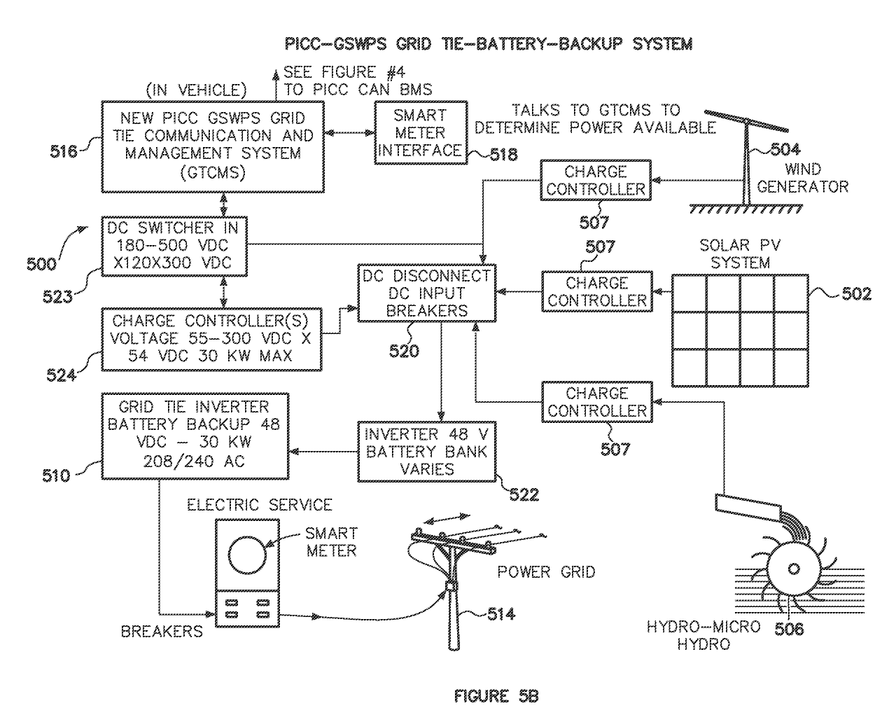

In some embodiments, the grid tie system can additionally connect other power sources to a power system. As depicted in FIG. 5A, a grid tie system 500 can, for example, be connected to a variety of power sources including, a PHEV or EV, a photovoltaic system 502, a wind generation system 504, a hydro-generation system 506, or any other power generation system. As depicted in FIG. 5A, the photovoltaic system 502, the wind generation system 504, and the hydro-generation system 506 are each connected to a combiner box. In some embodiments, the combiner box 508 can be configured to combine power received from several sources into one line. In some embodiments, a combiner box will be configured for certain amounts of power. More specifically, some embodiments of a combiner box can be configured for less than 200 kilowatts, less than 100 kilowatts, or less than 30 kilowatts. A person of skill in the art will recognize that the configuration of a combiner box can be selected in light of power generation resources and system requirements and that addition of other known electrical components, such as transformers, enable the use of a variety of components in connection with a single combiner box.

In some embodiments, power exits the combiner box 508 and passes to the inverter 510. The inverter 510 transforms the direct current electricity generated by one or more of the photovoltaic system 502, the wind generation system 504, and the hydro-generation system 506 into alternating current electricity. The inverter can, in some embodiments, be configured to transform electricity having a specified voltage and power range. In some embodiments, the inverter can be configured, for example, to transform electricity with voltages ranging from 10 to 500 Vdc, from 100 to 300 Vdc, or from 180 to 240 Vdc. In further aspects, the inverter can be configured, for example, to transform electricity at less that 200 kilowatts, less than 100 kilowatts, or less than 30 kilowatts. In some aspects the grid tie inverter 510 can be configured to transform electricity to having different phases. In some aspects, the inverter 510 can transform electricity to having single phase or three phases, or any other known phases of electricity.

Electricity exits the inverter 510 and can, in some embodiments, pass through a meter 512 before entering into the power system 514. As discussed above, a meter 512 can, in some embodiments, be configured to track the amount of power put back into the power grid 514, thereby enabling the owner of the generated electricity to collect payment or receive credit for the power.

In some additional embodiments, a grid tie controller 516 can be, for example integrally connected with aspects of the grid tie system 500. In some embodiments, the grid tie controller 516 can be connected to dc switcher 523, which can be connected to the combiner box 508. As discussed above, the dc switcher 523 can include, for example, an lhv dc dc switcher configured to protect against power surges and provide an upper limit to the amount power passing through the dc switcher. The grid tie system controller 516 can, in some aspects, be additionally connected to a smart meter interface 518. The grid tie system controller 516 and the smart meter interface 518 can, for example, communicate with the power grid 514 to provide power to the grid as power is required. In some embodiments, and as discussed above, additional power needs can be supplied by a PHEV or EV in communication with the grid tie system controller 516. This power can, in some embodiments, be generated by the PHEV or EV, or, in other embodiments, taken from power stored in the PHEV or EV battery.

A person skilled in the art will recognize that the present disclosure is not limited to the specific components or power generation sources depicted in FIG. 5A, but includes techniques of interactively supplying power to the power grid as required. One or more of the components depicted in 5A can, in some aspects, be excluded, and additional components can also be included, if desired.

FIG. 5B depicts another embodiment of a grid tie system 500. As depicted in FIG. 5B, a grid tie system 500 can, for example, be connected to a variety of power sources including, a PHEV or EV, a photovoltaic system 502, a wind generation system 504, a hydro-generation system 506, or any other power generation system. As depicted in FIG. 5A, the photovoltaic system 502, the wind generation system 504, and the hydro-generation system 506 are each connected to a charge controller 507. In some configurations, each of the photovoltaic system 502, the wind generation system 504, and the hydro-generation system 506 are connected to a unique charge controller 507. In other configurations, the photovoltaic system 502, the wind generation system 504, and the hydro-generation system 506 are all connected to a single charge controller 507. A person of skill in the art will recognize that the present disclosure is not limited to the specific configuration of charge controllers, but extends to the broader concept of utilizing a charge controller in connection with power generation.

In some embodiments, power can exit the one or several charge controllers 507 and pass to DC disconnect 520. In some embodiments, the DC disconnect 520 can be configured to turn dc power on or to shut dc power off.

In some aspects of a grid tie system 500, power can exit the dc disconnect 520 and pass to the battery bank 522. A battery bank 522 can be configured to store power generated above the needs of the power grid 514. In some embodiments, the battery bank 522 can be configured to provide power as needed when power generation is less than required by the power grid 514. The battery bank 522 can comprise a wide range of voltages and amperages. In some configurations, the battery bank 522 can be configured, for example, for approximately 250 volts, 100 volts, or 48 volts.

In some embodiments, power exits the battery bank 522 and passes to the inverter 510. The inverter 510 transforms the direct current electricity generated by the photovoltaic system 502, the wind generation system 504, and the hydro-generation system 506 into alternating current electricity. In some aspects the grid tie inverter 510 can be configured to transform electricity to having different phases. In some aspects, the inverter 510 can transform electricity to having single phase or three phase, or any other known phases of electricity. In some embodiments, the grid tie inverter 510 can be configured to further comprise a battery back-up. The battery back-up can, for example, provide power to the any home or commercial electrical system connected to the grid tie system 500 such as, for example, a customer's power system, or the power grid 514, when other power sources fail to generate sufficient power. A battery back-up can provide a variety of watts of power at a variety of voltages. In some embodiments, the battery back-up can provide electricity at approximately 250 volts, approximately 100 volts, or approximately 48 volts. In some embodiments, a battery back-up can provide approximately 200 watts, approximately 100 watts, or approximately 30 watts. Electricity exits the inverter 510 and can, in some embodiments, pass through a meter 512 before entering into the power system 514. As discussed above, a meter 512 can, in some embodiments, be configured to track the amount of power put back into the power grid 514, thereby enabling the owner of the generated electricity to collect payment or receive credit for the power.

In some additional embodiments in which a pre-existing grid tie system is configured for connection with a PHEV, an auto transformer can, for example, transform PHEV generated power to match the pre-existing system needs. In some aspects, for example, an auto transformer can be configured to transform electricity to a voltage and phase compatible with pre-existing system components, such as, for example, a pre-existing inverter. In some embodiments, an auto transformer can be configured for use with electricity from 0 Vdc to 600 Vdc and from 600 to 1200 Vdc bipolar. In some embodiments an auto transformer can comprise a transformer, a digital voltage controller, or an analog voltage controller.

In some additional embodiments, a grid tie controller 516 can be, for example integrally connected with aspects of the grid tie system 500. In some embodiments, the grid tie controller 516 can be connected to dc switcher 523, which can be connected to the combiner box 508. As discussed above, the dc switcher 523 can include, for example, a lhv dc dc switcher. The grid tie system controller 516 can, in some aspects, be additionally connected to a smart meter interface 518. The grid tie system controller 516 and the smart meter interface 518 can, for example, communicate with the power grid 514 to provide power to the grid as power is required. In some embodiments, and as discussed above, additional power needs can be supplied by a PHEV or EV in communication with the grid tie system controller 516. This power can, in some embodiments, be generated by the PHEV or EV, or, in other embodiments, taken from power stored in the PHEV or EV battery. Power generated by the PHEV or EV can, in some embodiments, be passed to the dc switcher 523 and to the charge controller 524. As discussed above, a charge controller 524 can, in some configurations, control the rate at which current flows into or out of a battery. A charge controller 524 can, in some aspects, be configured to regulate power and voltage of electricity. In some configurations, a charge controller 524 can be configured to regulate electricity having voltages between approximately 10 and 500 volts, approximately 50 and 300 volts, or 180 and 240 volts. In some aspects, the charge controller can accept a wide range of voltages of electricity. In one aspect, the charge controller 524 can accept, for example, 240 Vdc to 52 Vdc. Additionally, a charge controller 524 can be further configured for less than approximately 200 kilowatts, 100 kilowatts, or 25 kilowatts. The power can, in some embodiments, flow from the charge controller 524 to the dc disconnect 520 at which point the power flows in the same manner as power generated by the photovoltaic system 502, the wind generation system 504, or the hydro-generation system 506.

Additionally, in some embodiments, the PHEV can be integrated into a customer's power system. In some embodiments, a PHEV can be configured for use as a back-up green generator or as a backup power resource. In some aspects, the PHEV can be, for example, communicatingly integrated with the customer power system to provide power in case of a power shortfall, such as, for example, in case of a black-out, cloudy weather, a power emergency, or other times of need.

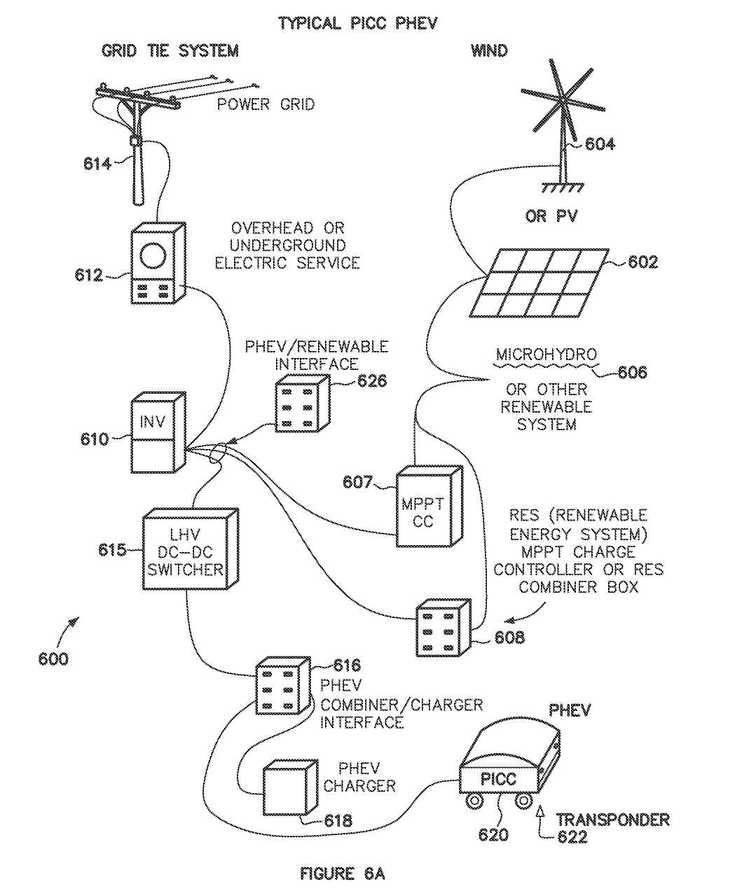

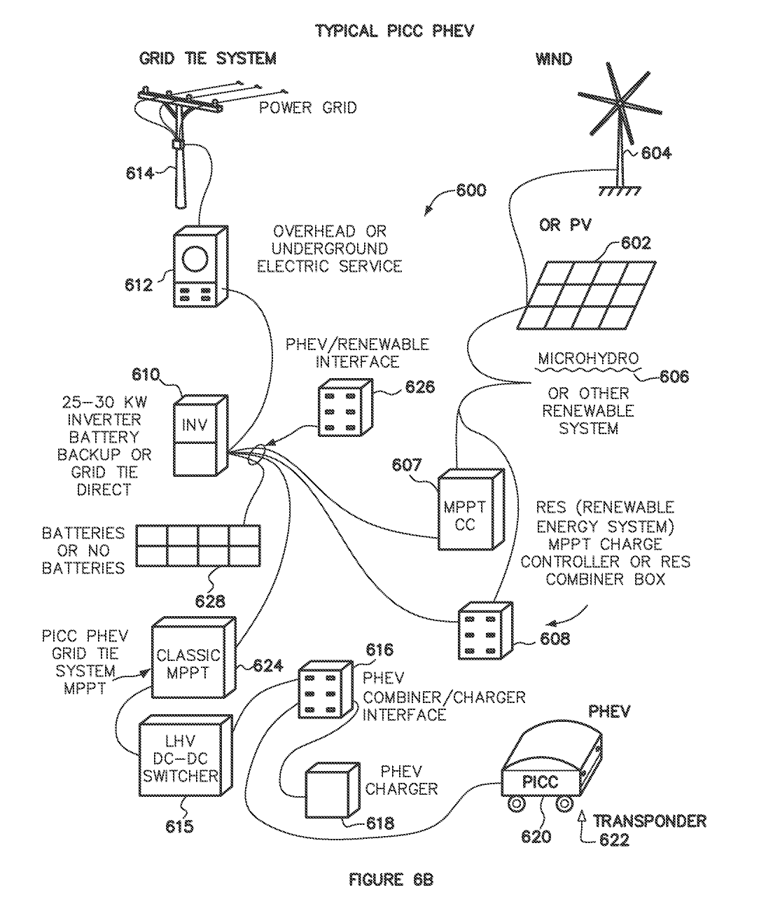

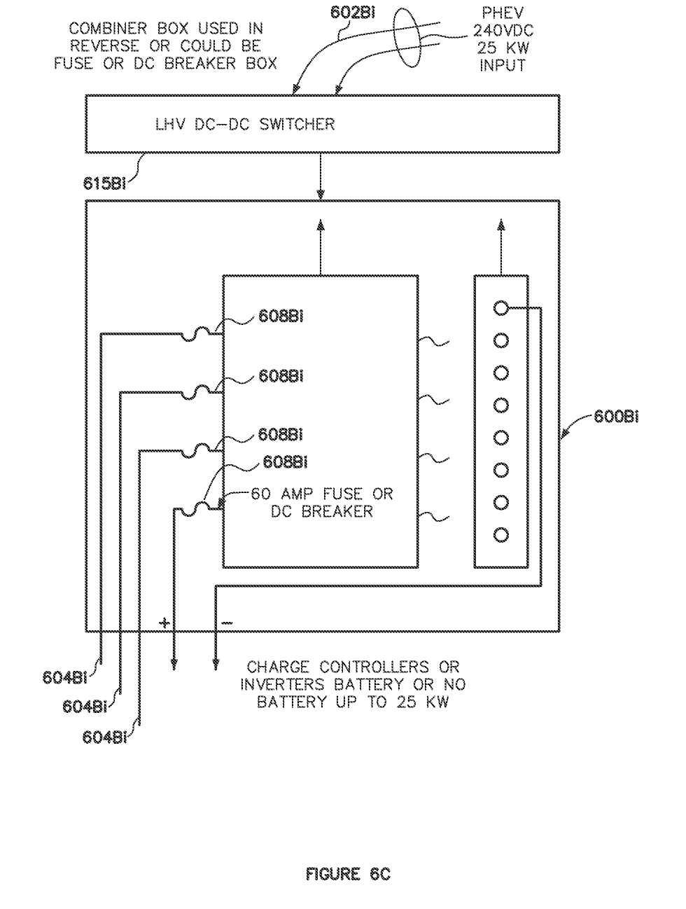

FIGS. 6A and 6B depict other embodiments of a grid tie system 600. More specifically, FIG. 6A depicts one embodiment of a grid tie system 600 that can, for example, be connected to a variety of power sources including, a PHEV or EV, a photovoltaic system 602, a wind generation system 604, a hydro-generation system 606, or any other power generation system. As depicted in FIG. 6A, the photovoltaic system 602, the wind generation system 604, and/or the hydro-generation system 606 can connect to a charge controller 607. In some embodiments, a charge controller 607 can be configured to regulate the flow of power to and from a power system, such as a power grid, or to and from a power storage component, such as a battery. In some embodiments, the photovoltaic system 602, the wind generation system 604, and the hydro-generation system 606 can connect to a combiner box 608. A combiner box can be configured to combine the individual outputs of, for example, each of the photovoltaic system 602, the wind generation system 604, and the hydro-generation system 606 into a single output. A person of skill in the art will recognize that the inclusion and respective positioning of a charge controller 607 and combiner box 608 can vary according to the specific needs of the grid tie system 600. In some embodiments, a combiner box 608 or a charge controller 607 can be configured for certain amounts of power. More specifically, some embodiments of a combiner box 608 or charge controller 607 can be configured for less than 200 kilowatts, less than 100 kilowatts, or less than 30 kilowatts. A person of skill in the art will further recognize that some embodiments of a grid tie system 600 may not include either or both of a combiner box 608 or a charge controller 607.

As further depicted in FIG. 6A, a grid tie system 600 can, in some embodiments, include an inverter 610. The inverter 610 can, for example, transform the type of current of electricity passing through the inverter. In some embodiments, the inverter 610 can be configured to convert the direct current electricity generated by the photovoltaic system 602, the wind generation system 604, and/or the hydro-generation system 606 into alternating current. In other embodiments, the inverter 610 can be configured to convert alternating current into direct current. In some additional embodiments, the inverter 610 can be configured to convert alternating current to direct current and direct current to alternating current.

Some embodiments of a grid tie system 600 can further include a meter 612. In some embodiments, and as depicted in FIG. 6A, the meter 612 can connect to the inverter 610. In further embodiments, the meter 612 can connect to the power system 614. As depicted in FIG. 6A, electricity can pass from the inverter 610, through the meter 612, and then into the power system 614. As discussed above, a meter 612 can, for example, be configured to track the amount of power put back into the power system 614, thereby enabling the owner of the generated electricity to collect payment or receive credit for the power.

Embodiments of a grid tie system 600 can further include a combiner charger interface 616, a PHEV charger 618, a transponder 622, and/or a PHEV/RES interface 626. A PHEV/RES interface 626 can be configured to combine multiple inputs and/or outputs from other components of the grid tie system 600, such as, for example, the charge controller 607, the combiner box 608, and/or a dc switcher 615 which can be connected, for example, to the PHEV combiner charger interface 616, into a single input and/or output.

A PHEV charger 618 can be configured for charging of energy storage components, such as batteries, in the PHEV 620. In some embodiments, the PHEV charger 618 can connect to a controller configured to regulate battery charging by receiving information relating to the state of charge of the batteries or the temperature of the batteries, the charger, or other electrical components. In some embodiments, a PHEV charger 618 can independently connect to a power system 614 by a circuit separate from the grid tie system 600. In other embodiments, the PHEV charger 618 can be connected to the grid tie system 600 and/or independently connected to the power system 614. A PHEV charger 618 can directly connect to a PHEV 620, or can connect to a PHEV combiner charger interface 616.

As discussed above, a transponder 622 can, for example, be configured to provide information to the grid tie system 600 relating to the position of the PHEV. The transponder 622 can, for example, ascertain the position of the PHEV through a sensor, such as, for example, an RFID tag and reader, a pressure sensor, or other sensing components.

A PHEV combiner charger interface 616 can, in some embodiments, be configured to controllably connect the PHEV 620 to a PHEV charger 616 or other components in the grid tie system 600 such as the PHEV/RES interface 626 or the inverter 610. In some embodiments, a PHEV combiner charger interface 616 can comprise a double pole, double throw switch configured for switching connection between the PHEV 620 and components of the grid tie system 600 such as the PHEV charger 618 of the inverter 610. A PHEV combiner charger interface 616 can further communicatingly connect to a controller, the controller configured to receive information relating to the desired function of the grid tie system 600 and to provide control signals to the PHEV combiner charger interface 616 relating to the desired switching configuration. Thus, in one embodiment, the PHEV combiner charger interface 616 can receive a signal calling for charging and calling for connection between the PHEV charger 618 and the PHEV 620. In other embodiments, the PHEV combiner charger interface 616 can receive a signal calling for power generation and calling for connection between the PHEV 620 and other components of the grid tie system 600 such as the inverter 610 or the PHEV/RES interface 626.

In some embodiments of a grid tie system 600, power is generated by a photovoltaic system 602, a wind generation system 604, a hydro-generation system 606, or any other power generation system. Additionally, power is available from the power system 614. In some embodiments in which a controller determines that the power generated by a photovoltaic system 602, a wind generation system 604, a hydro-generation system 606, or any other power generation system exceeds power needs, power can flow from each of these systems, through the charge controller 607 and/or the combiner box 608, through the PHEV/RES interface 626 to the inverter 610, and through the meter 612 to the power system 614.

In some embodiments of a grid tie system 600, a PHEV 620 is attached to the grid tie system 600. In one configuration, the PHEV 620 may request charging or the grid tie system 600 may select or default to charging. A controller can, in some configurations, respond to the request or default to charging by determining available power resources. If sufficient power is available for charging, one embodiment of a controller can send signals to begin charging. In one embodiment, power for charging can come from the power system 614. In one aspect of this embodiment, power can flow from the power system 614, through the meter 612 and the inverter 610 to the PHEV/RES interface 626, through the dc switcher 615, and through the PHEV charger 618 and PHEV combiner charger interface 616 to the PHEV 620. In another aspect, power can flow from power system 614 directly to the PHEV charger 618, and through the PHEV combiner charger interface to the PHEV 620.

In another aspect of the grid tie system 600, power for charging can, for example, originate, wholly or partially, in grid tie connected generation resources. In embodiments in which power is generated by a photovoltaic system 602, a wind generation system 604, a hydro-generation system 606, or any other power generation system, a controller can determine whether power generation is in excess of power consumption. If a photovoltaic system 602, a wind generation system 604, a hydro-generation system 606, or any other power generation system is generating power in excess of needs, power can flow from each of these systems, through the charge controller 607 and/or the combiner box 608, to the PHEV/RES interface 626. In some embodiments, the PHEV/RES interface 626 can, for example, route the power through the PHEV charger 618 or the PHEV combiner charger interface 616 and to the PHEV. Additionally, in some embodiments, power from a photovoltaic system 602, a wind generation system 604, a hydro-generation system 606, or any other power generation system can supplement power from the power source 614 to charge the PHEV.

In another aspect of the grid tie system 600, the controller can delay charging until power is available if the controller receives a request for or defaults to charging and determines that power is not available for charging.

In another aspect of the grid tie system 600, if the power system 614 signals a need for additional power, the controller can query power generation components, such as a photovoltaic system 602, a wind generation system 604, a hydro-generation system 606, a PHEV 620, or any other power generation system connected to the grid tie system 600 to determine whether power can be provided to the power system 614. In some embodiments, a conversion BMS in the PHEV 620 can, in connection with other components of a grid tie system 600 determine the available power resources of the PHEV 620. This determination can include evaluation of state of charge of PHEV 620 batteries, PHEV 620 fuel levels, PHEV 620 location, as determined, for example, by transponder 622, or any other factor relevant to power generation. In embodiments in which the PHEV 620 has available power resources, the power can pass from the PHEV 620 through the PHEV combiner charger interface 616, the dc switcher 615, and the PHEV/RES interface 626 to the inverter. In some embodiments, power passing through the inverter can be converted from direct current to alternating current before passing through the meter 612 to the power system 614.

FIG. 6B depicts one embodiment of a grid tie system 600 that can, for example, be connected to a variety of power sources including, a PHEV or EV, a photovoltaic system 602, a wind generation system 604, a hydro-generation system 606, or any other power generation system. As depicted in FIG. 6B, the photovoltaic system 602, the wind generation system 604, and/or the hydro-generation system 606 can connect to a charge controller 607. In some embodiments, a charge controller 607 can be configured to regulate the flow of power to and from a power system, such as a power grid, or to and from a power storage component, such as a battery. In some embodiments, the photovoltaic system 602, the wind generation system 604, and the hydro-generation system 606 can connect to a combiner box 608. A combiner box can be configured to combine the individual outputs of, for example, each of the photovoltaic system 602, the wind generation system 604, and the hydro-generation system 606 into a single output. A person of skill in the art will recognize that the inclusion and respective positioning of a charge controller 607 and combiner box 608 can vary according to the specific needs of the grid tie system 600. In some embodiments, a combiner box 608 or a charge controller 607 can be configured for certain amounts of power. More specifically, some embodiments of a combiner box 608 or charge controller 607 can be configured for less than 200 kilowatts, less than 100 kilowatts, or less than 30 kilowatts. A person of skill in the art will further recognize that some embodiments of a grid tie system 600 may not include either or both of a combiner box 608 or a charge controller 607.

As further depicted in FIG. 6B, a grid tie system 600 can, in some embodiments, include an inverter 610. The inverter 610 can, for example, transform the type of current of electricity passing through the inverter. In some embodiments, the inverter 610 can be configured to convert the direct current electricity generated by the photovoltaic system 602, the wind generation system 604, and/or the hydro-generation system 606 into alternating current. In other embodiments, the inverter 610 can be configured to convert alternating current into direct current. In some additional embodiments, the inverter 610 can be configured to convert alternating current to direct current and direct current to alternating current.

As further depicted in FIG. 6B, some embodiments of a grid tie system 600 can include energy storage components, such as batteries 628 and/or at least one charge controller 624. In some embodiments, the charge controller 624 can be configured to control the rate of charge and discharge of the batteries 628. In some embodiments, the charge controller 624 can, for example, monitor aspects of the batteries 628 to control the rate of charge or discharge, including, state of charge and/or temperature. In some aspects of a grid tie system 600, a plurality of charge controllers 624 can, for example, be connected to PHEV combiner charger interface 616 via the dc switcher 615, and to batteries 628. In this configuration, the PHEV combiner charger interface 616 can split current generated by the PHEV 620 into multiple smaller currents to match the capabilities of the individual charge controllers 624. In this embodiment, as shown in FIG. 6C, a standard combiner box 600C can, for example, be configured for splitting a single input 602C into multiple outputs 604C by wiring the normal combiner box output as an input, and the normal combiner box inputs as outputs. In some embodiments, and as depicted in FIG. 6C, the input 602C can pass through a dc switcher 615C before entering the combiner box 600C. As further depicted in FIG. 6C, a combiner box 600C can include at least one input fuse 606C, which can, in some embodiments, be configured as a 125 A fuse or a DC breaker. A combiner box 600C can, for example, further include at least one output fuse 608C, which can, in some embodiments, be configured as a 60 A fuse or a DC breaker. A person of skill in the art will recognize that a variety of configurations of combiner boxes can be used in embodiments of a grid tie system and that a grid tie system is not limited to specific above-outlined embodiments.

In some embodiments, power from the individual charge controllers 624 can then pass to the batteries 628, or, in embodiments in which the batteries 628 do not need additional power, excess power can pass to the power system. This can, in some embodiments, enable use of smaller and better adapted charge controllers 624 in connection with the grid tie system 600.

The batteries 628 can be configured to store excess power generated by power generating components connected to the grid tie system 600 such as, for example, a photovoltaic system 602, a wind generation system 604, a hydro-generation system 606, a PHEV 620, or any other power generation system. The batteries 628 can be sized and configured to provide power to the power system 614 or to any component connected to the grid tie system 600 as power needs arise.

Some embodiments of a grid tie system 600 can further include a meter 612. In some embodiments, and as depicted in FIG. 6B, the meter 612 can connect to the inverter 610. In further embodiments, the meter 612 can connect to the power system 614. As depicted in FIG. 6B, electricity can pass from the inverter 610, through the meter 612, and then into the power system 614. As discussed above, a meter 612 can, for example, be configured to track the amount of power put back into the power system 614, thereby enabling the owner of the generated electricity to collect payment or receive credit for the power.

Embodiments of a grid tie system 600 can further include a combiner charger interface 616, a PHEV charger 618, a transponder 622, and/or a PHEV/RES interface 626. A PHEV/RES interface 626 can be configured to combine multiple inputs and/or outputs from other components of the grid tie system 600, such as, for example, the charge controller 607, the combiner box 608, and/or the PHEV combiner charger interface 616 into a single input and/or output.

A PHEV charger 618 can be configured for charging of energy storage components, such as batteries, in the PHEV 620. In some embodiments, the PHEV charger 618 can connect to a controller configured to regulate battery charging by receiving information relating to the state of charge of the batteries or the temperature of the batteries, the charger, or other electrical components. In some embodiments, a PHEV charger 618 can independently connect to a power system 614 by, for example, a circuit separate from the grid tie system 600. In other embodiments, the PHEV charger 618 can be connected to the grid tie system 600 and/or independently connected to the power system 614. A PHEV charger 618 can directly connect to a PHEV 620, or can connect to a PHEV combiner charger interface 616.

As discussed above, a transponder 622 can, in some embodiments, be configured to provide information to the grid tie system 600 relating to the position of the PHEV. The transponder 622 can ascertain the position of the PHEV through a sensor, such as, for example, an RFID tag and reader, a pressure sensor, or other sensing components.

A PHEV combiner charger interface 616 can, in some embodiments, be configured to controllably connect the PHEV 620 to a PHEV charger 616 or other components in the grid tie system 600 such as the PHEV/RES interface 626 or the inverter 610. In some embodiments, a PHEV combiner charger interface 616 can comprise a double pull, double throw switch configured for switching connection between the PHEV 620 and components of the grid tie system 600 such as the PHEV charger 618 of the inverter 610. A PHEV combiner charger interface 616 can further communicatingly connect to a controller, the controller configured to receive information relating to the desired function of the grid tie system 600 and to provide control signals to the PHEV combiner charger interface 616 relating to the desired switching configuration. Thus, in one embodiment, the PHEV combiner charger interface 616 can receive a signal calling for charging and calling for connection between the PHEV charger 618 and the PHEV 620. In other embodiments, the PHEV combiner charger interface 616 can receive a signal calling for power generation and calling for connection between the PHEV 620 and other components of the grid tie system 600 such as the inverter 610 or the PHEV/RES interface 626.

In some embodiments of a grid tie system 600, power is generated by a photovoltaic system 602, a wind generation system 604, a hydro-generation system 606, or any other power generation system. Additionally, power is available from the power system 614. In some embodiments in which a controller determines that the power generated by a photovoltaic system 602, a wind generation system 604, a hydro-generation system 606, or any other power generation system exceeds power needs, power can flow from each of these systems, through the charge controller 607 and/or the combiner box 608, through the PHEV/RES interface 626 to the inverter 610, and through the meter 612 to the power system 614.

In some embodiments of a grid tie system 600, a PHEV 620 is attached to the grid tie system 600. In one configuration, the PHEV 620 may request charging or the grid tie system 600 may select or default to charging. A controller can, in some configurations, respond to the request or default to charging by determining available power resources. If sufficient power is available for charging, one embodiment of a controller can send signals to begin charging. In one embodiment, power for charging can come from the power system 614. In one aspect of this embodiment, power can flow from the power system 614, through the meter 612 and the inverter 610 to the PHEV/RES interface 626, through the dc switcher 615, and through the PHEV charger 618 and PHEV combiner charger interface 616 to the PHEV 620. In another aspect, power can flow from power system 614 directly to the PHEV charger 618, and through the PHEV combiner charger interface to the PHEV 620. In some embodiments, this can, for example, occur via the net metering system. In some off-the-grid embodiments, this can, for example, power can pass through the inverter to the PHEV.

In another aspect of the grid tie system, power for charging of the PHEV can, for example, be taken from the batteries 628. In this embodiment, power can flow from the batteries 628 through the charge controller 624, through the dc switcher 615, and the PHEV combiner charger interface 616 to the PHEV 620.

In another aspect of the grid tie system 600, power for charging can, for example, originate, wholly or partially, in grid tie connected generation resources. In embodiments in which power is generated by a photovoltaic system 602, a wind generation system 604, a hydro-generation system 606, or any other power generation system, a controller can determine whether power generation is in excess of power consumption. If a photovoltaic system 602, a wind generation system 604, a hydro-generation system 606, or any other power generation system is generating power in excess of needs, power can flow from each of these systems, through the charge controller 607 and/or the combiner box 608, to the PHEV/RES interface 626. In some embodiments, PHEV/RES interface 626 can, for example, route the power through the dc switcher 615 and through the PHEV charger 618 or the PHEV combiner charger interface 616 and to the PHEV 620. Additionally, in some embodiments, power from a photovoltaic system 602, a wind generation system 604, a hydro-generation system 606, or any other power generation system can supplement power from the power source 614 to charge the PHEV.

In another aspect of the grid tie system 600, the controller can delay charging until power is available if the controller receives a request for or defaults to charging and determines that power is not available for charging.

In another aspect of the grid tie system 600, if the power system 614 signals a need for additional power, the controller can query power generation components, such as a photovoltaic system 602, a wind generation system 604, a hydro-generation system 606, a PHEV 620, or any other power generation system connected to the grid tie system 600 and energy storage components, such as batteries 628, to determine whether power can be provided to the power system 614. In some embodiments, a conversion BMS in the PHEV 620 can, in connection with other components of a grid tie system 600 determine the available power resources of the PHEV 620. This determination can include evaluation of state of charge of PHEV 620 batteries, PHEV 620 fuel levels, PHEV 620 location, as determined, for example, by transponder 622, or any other factor relevant to power generation. In embodiments in which the PHEV 620 has available power resources, the power can pass from the PHEV 620 through the PHEV combiner charger interface 616 and the PHEV/RES interface 626 to the inverter. In some embodiments, power can be taken from available resources and in passing through the inverter can be converted from direct current to alternating current before passing through the meter 612 to the power system 614.

A person of skill in the art will recognize that a grid tie system and connected PHEV can be used in a variety of different methods. As discussed above, a grid tie system and PHEV can be configured to provide power to a power system. These systems can include, for example, a power grid. In some other embodiments, the grid tie system and PHEV can be configured to provide power to a user's power system. Thus, in some embodiments, a PHEV and grid tie system can, for example, be configured to generate power when the power grid or other power sources fail to provide adequate power to supply the user's needs. In some embodiments, a PHEV can function as a green generator in a user's power system. In other embodiments, a PHEV can be connected to the user's power system by, for example, an automatic transfer switch. In some aspects, an automatic transfer switch can be configured to automatically transfer power to a user's power system in case of inadequate power supply by other sources. A person of skill in the art will recognize that a PHEV and grid tie system can be used a variety of configurations and for a variety of purposes and is not limited by the above explicitly described embodiments.

A person skilled in the art will recognize that each of these sub-systems can be inter-connected and controllably connected using a variety of techniques and hardware and that the present disclosure is not limited to any specific method of connection or connection hardware. One or more of the components depicted in the figures can, in some aspects, be excluded, and additional components can also be included, if desired.

The technology is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A kit for converting a standard hybrid vehicle into a plug in hybrid vehicle (PHEV), the kit comprising:
connection hardware, wherein the connection hardware is configured to electrically connect the battery to an off-vehicle power source;
at least one battery configured to match the voltage of the original hybrid battery,
battery management software, wherein the battery management software is configured to provide information relating to battery performance to an engine control unit, wherein the battery is further configured to maintain charge balance between each of the cells of the battery; and,
suspension components.

2. The kit of claim 1, further comprising a 50 Ah, 201.6 Vdc battery.

3. The kit of claim 1, further comprising a 30 Ah, 201.6 Vdc battery.

4. The kit of claim 1, further comprising a 6.5 Ah, 201.6 Vdc battery.

5. The kit of claim 1, wherein the battery management software is configured to manage the cell performance of the battery.

6. The kit of claim 5, wherein the battery management software is configured to maintain a substantially equal charge across all of the battery cells.

7. The kit of claim 6, wherein the battery management software is configured to maintain an equal charge +/−0.07 Vdc across all of the battery cells

8. A method of selectively integrating a PHEV into a power system with a grid tie system, the method comprising,
determining whether to charge at least one battery in the PHEV, wherein the grid tie system requests information relating to available power resources internal and external to the grid tie system, wherein the grid tie system requests information relating to vehicle parameters; wherein the grid tie system compares information received from the power system and from the PHEV to predetermined charging criteria, wherein the grid tie system allows or denies charging based on predetermined criteria;
determining whether the power system requires power, wherein the grid tie system receives in a request for available power resources from the power system;
determining available power resources, wherein the grid tie system requests information from the PHEV relating to the amount of available power resources; wherein the state of charge of the PHEV batteries, the amount of fuel available for use in power generation, and the location of the vehicle are used in determining available power resources; and
requesting delivery of available power resources to the grid tie system, wherein the grid tie system requests delivery of available battery resources and available vehicle generated power resources.

9. The method of claim 8, wherein a transponder is used to determine the location of the vehicle.

10. The method of claim 8, wherein the vehicle has fewer available power resources when the vehicle is in a first location.

11. The method of claim 8, wherein the vehicle has more available power resources when the vehicle is in a second location.

12. The method of claim 8, wherein a grid tie system controller communicates with the power system through a smart meter.

13. The method of claim 8, wherein a grid tie system controller communicates with the PHEV.

14. The method of claim 8, wherein a high voltage charge controller is configured to charge an off-vehicle battery bank.

15. The method of claim 14, wherein the off-vehicle battery bank is configured to provide back-up power to existing power systems.

16. A method of increasing the performance of at least one battery configured for use in a PHEV, wherein the battery is configured with the same maximum voltage as the original vehicle battery, the method comprising;
controllably cycling the charging and discharging of the battery, the cycling comprising:
battery charging, wherein the battery is charged to a first state of charge in charging cycling, and
discharging, wherein discharging comprises:
regular discharging, wherein the battery is discharged to second state of charge, and
deep discharging, wherein the battery is discharged to a third state of charge.

17. The method of claim 14, wherein the first state of charge comprises a 90 percent state of charge.

18. The method of claim 14, wherein the second state of charge comprises a 23 percent state of charge.

19. The method of claim 14, wherein the third state of charge comprises a 5 percent state of charge.

20. The method of claim 14, wherein the battery cycle comprises one deep discharge cycle for at least every twenty regular discharge cycles.

21. The method of claim 14, wherein the battery cycle comprises one deep discharge cycle every month.

22. A method of maximizing battery usage in a PHEV, wherein the cycling of the battery increases battery performance and battery life, the method comprising;
requesting vehicle operator input relating to desired vehicle operation mode,
requesting vehicle operator input relating to estimated trip length;
requesting information relating to battery charge parameters;
allowing vehicle operation in the user requested mode when battery criteria exceed threshold levels;
denying vehicle operation in the user requested mode when battery criteria fail to exceed threshold levels;
limiting the rate of battery power availability according to predetermined criteria, wherein the predetermined criteria are created to maximize ideal cycling of the vehicle battery during each trip, wherein ideal cycling comprises discharging the vehicle battery from a first state of charge to a second state of charge.

23. The method of claim 20, wherein the first state of charge comprises a 90 percent state of charge.

24. The method of claim 20, wherein the second state of charge comprises a 23 percent state of charge.

25. The method of claim 20, wherein the desired vehicle operation mode comprises the factory vehicle operation mode.

26. The method of claim 20, wherein the desired vehicle operation mode comprises limiting vehicle top speed.

27. The method of claim 20, wherein the desired vehicle operation mode comprises solely electric power below a designated speed.

28. The method of claim 25, wherein the vehicle operation mode uses solely electric power below 72 miles per hour.
